(19) United States
(12) Patent Application Publication
(10) Pub. No.: US 2021/0136120 A1
(43) Pub. Date: May 6, 2021

(54) UNIVERSAL COMPUTING ASSET REGISTRY

(71) Applicant: QOMPLX, Inc., Tysons, VA (US)

(72) Inventors: Jason Crabtree, Vienna, VA (US); Andrew Sellers, Monument, CO (US); Randy Clayton, Frederick, MD (US); Angad Salaria, Herndon, VA (US); Roman Tejada, Vienna, VA (US)

(21) Appl. No.: 16/945,698

(22) Filed: Jul. 31, 2020

Related U.S. Application Data
(63) Continuation-in-part of application No. 16/864,133, filed on Apr. 30, 2020.
Application No. 16/864,133 is a continuation-in-part of application No. 15/847,443, filed on Dec. 19, 2017.
Application No. 15/847,443 is a continuation-in-part of application No. 15/790,457, filed on Oct. 23, 2017, now Pat. No. 10,884,999.
Application No. 15/790,457 is a continuation-in-part of application No. 15/790,327, filed on Oct. 23, 2017, now Pat. No. 10,860,951.
Application No. 15/790,327 is a continuation-in-part of application No. 15/616,427, filed on Jun. 7, 2017.
Application No. 15/616,427 is a continuation-in-part of application No. 15/141,752, filed on Apr. 28, 2016, now Pat. No. 10,860,962.
Application No. 15/141,752 is a continuation-in-part of application No. 15/091,563, filed on Apr. 5, 2016, now Pat. No. 10,204,147.
Application No. 15/091,563 is a continuation-in-part of application No. 14/986,536, filed on Dec. 31, 2015, now Pat. No. 10,210,255.
Application No. 14/986,536 is a continuation-in-part of application No. 14/925,974, filed on Oct. 28, 2015, now abandoned.
Application No. 14/925,974 is a continuation-in-part of application No. 16/864,133, filed on Apr. 30, 2020.
Application No. 16/864,133 is a continuation-in-part of application No. 16/847,443, filed on Apr. 13, 2020.
Application No. 15/847,443 is a continuation-in-part of application No. 15/616,427, filed on Jun. 7, 2017.
Application No. 15/616,427 is a continuation-in-part of application No. 14/925,974, filed on Oct. 28, 2015, now abandoned.
Application No. 14/925,974 is a continuation-in-part of application No. 16/864,133, filed on Apr. 30, 2020.
Application No. 16/864,133 is a continuation-in-part of application No. 15/847,443, filed on Dec. 19, 2017.
Application No. 15/847,443 is a continuation-in-part of application No. 15/489,716, filed on Apr. 17, 2017.
Application No. 15/489,716 is a continuation-in-part of application No. 15/409,510, filed on Jan. 18, 2017.
Application No. 15/409,510 is a continuation-in-part of application No. 15/379,899, filed on Dec. 15, 2016.
Application No. 15/379,899 is a continuation-in-part of application No. 15/376,657, filed on Dec. 13, 2016, now Pat. No. 10,402,906.
Application No. 15/376,657 is a continuation-in-part of application No. 15/237,625, filed on Aug. 15, 2016, now Pat. No. 10,248,910.
Application No. 15/237,625 is a continuation-in-part of application No. 15/206,195, filed on Jul. 8, 2016.
Application No. 15/206,195 is a continuation-in-part of application No. 15/186,453, filed on Jun. 18, 2016.
Application No. 15/186,453 is a continuation-in-part of application No. 15/166,158, filed on May 26, 2016.
Application No. 15/166,158 is a continuation-in-part of application No. 15/141,752, filed on Apr. 28, 2016, now Pat. No. 10,860,962.
Application No. 15/141,752 is a continuation-in-part of application No. 16/915,176, filed on Jun. 29, 2020.
Application No. 16/915,176 is a continuation-in-part of application No. 15/847,443, filed on Dec. 19, 2017.
Application No. 15/847,443 is a continuation-in-part of application No. 16/915,176, filed on Jun. 29, 2020.
Application No. 16/915,176 is a continuation-in-part of application No. 15/891,329, filed on Feb. 7, 2018.
Application No. 15/891,329 is a continuation-in-part of application No. 15/860,980, filed on Jan. 3, 2018.
Application No. 15/860,980 is a continuation-in-part of application No. 15/850,037, filed on Dec. 21, 2017.
Application No. 15/850,037 is a continuation-in-part of application No. 15/673,368, filed on Aug. 9, 2017.
Application No. 15/673,368 is a continuation-in-part of application No. 15/376,657, filed on Dec. 13, 2016, now Pat. No. 10,402,906.
Application No. 15/376,657 is a continuation-in-part of application No. 16/915,176, filed on Jun. 29, 2020.
Application No. 16/915,176 is a continuation-in-part of application No. 15/891,329, filed on Feb. 7, 2018.
Application No. 15/891,329 is a continuation-in-part of application No. 15/860,980, filed on Jan. 3, 2018.
Application No. 15/860,980 is a continuation-in-part of application No. 15/850,037, filed on Dec. 21, 2017.
Application No. 15/850,037 is a continuation-in-part of application No. 15/489,716, filed on Apr. 17, 2017.
Application No. 15/489,716 is a continuation-in-part of application No. 16/915,176, filed on Jun. 29, 2020.
Application No. 16/915,176 is a continuation-in-part of application No. 15/891,329, filed on Feb. 7, 2018.
Application No. 15/891,329 is a continuation-in-part of application No. 15/860,980, filed on Jan. 3, 2018.
Application No. 15/860,980 is a continuation-in-part of application No. 15/788,002, filed on Oct. 19, 2017.
Application No. 15/788,002 is a continuation-in-part of application No. 15/787,601, filed on Oct. 18, 2017, now Pat. No. 10,860,660.
Application No. 15/787,601 is a continuation-in-part of application No. 15/616,427, filed on Jun. 7, 2017.
Application No. 15/616,427 is a continuation-in-part of application No. 16/915,176, filed on Jun. 29, 2020.
Application No. 16/915,176 is a continuation-in-part of application No. 15/905,041, filed on Feb. 26, 2018, now Pat. No. 10,706,063.
Application No. 15/905,041 is a continuation-in-part of application No. 15/237,625, filed on Aug. 15, 2016, now Pat. No. 10,248,910.
Application No. 15/237,625 is a continuation-in-part of application No. 15/931,534, filed on May 13, 2020.
Application No. 15/931,534 is a continuation-in-part of application No. 16/777,270, filed on Jan. 30, 2020.
Application No. 16/777,270 is a continuation-in-part of application No. 16/720,383, filed on Dec. 19, 2019, now Pat. No. 10,944,795.
Application No. 16/720,383 is a continuation of application No. 15/823,363, filed on Nov. 27, 2017, now Pat. No. 10,560,483.
Application No. 15/823,363 is a continuation-in-part of application No. 15/725,274, filed on Oct. 4, 2017, now Pat. No. 10,609,079.
Application No. 15/725,274 is a continuation-in-part of application No. 15/655,113, filed on Jul. 20, 2017, now Pat. No. 10,735,456.
Application No. 15/655,113 is a continuation-in-part of application No. 15/616,427, filed on Jun. 7, 2017.
Application No. 15/616,427 is a continuation-in-part of application No. 14/925,974, filed on Oct. 28, 2015, now abandoned.
Application No. 14/925,974 is a continuation-in-part of application No. 15/931,534, filed on May 13, 2020.
Application No. 15/931,534 is a continuation-in-part of application No. 16/777,270, filed on Jan. 30, 2020.
Application No. 16/777,270 is a continuation-in-part of application No. 16/720,383, filed on Dec. 19, 2019, now Pat. No. 10,944,795.
Application No. 16/720,383 is a continuation of application No. 15/823,363, filed on Nov. 27, 2017, now Pat. No. 10,560,483.
Application No. 15/823,363 is a continuation-in-part of application No. 15/725,274, filed on Oct. 4, 2017, now Pat. No. 10,609,079.
Application No. 15/725,274 is a continuation-in-part of application No. 15/655,113, filed on Jul. 20, 2017, now Pat. No. 10,735,456.
Application No. 15/655,113 is a continuation-in-part of application No. 15/237,625, filed on Aug. 15, 2016, now Pat. No. 10,248,910.
Application No. 15/237,625 is a continuation-in-part of application No. 15/931,534, filed on May 13, 2020.
Application No. 15/931,534 is a continuation-in-part of application No. 15/683,765, filed on Aug. 22, 2017.
Application No. 15/683,765 is a continuation-in-part of application No. 15/409,510, filed on Jan. 18, 2017.
Application No. 15/409,510 is a continuation-in-part of application No. 15/379,899, filed on Dec. 15, 2016.
Application No. 15/379,899 is a continuation-in-part of application No. 15/376,657, filed on Dec. 13, 2016, now Pat. No. 10,402,906.
Application No. 15/376,657 is a continuation-in-part of application No. 15/237,625, filed on Aug. 15, 2016, now Pat. No. 10,248,910.
Application No. 15/237,625 is a continuation-in-part of application No. 15/931,534, filed on May 13, 2020.
Application No. 15/931,534 is a continuation-in-part of application No. 16/718,906, filed on Dec. 18, 2019.
Application No. 16/718,906 is a continuation of application No. 15/879,182, filed on Jan. 24, 2018, now Pat. No. 10,514,954.
Application No. 15/879,182 is a continuation-in-part of application No. 15/850,037, filed on Dec. 21, 2017.
Application No. 15/850,037 is a continuation-in-part of application No. 15/673,368, filed on Aug. 9, 2017.
Application No. 15/673,368 is a continuation-in-part of application No. 15/376,657, filed on Dec. 13, 2016, now Pat. No. 10,402,906.
Application No. 15/376,657 is a continuation-in-part of application No. 15/931,534, filed on May 13, 2020.
Application No. 15/931,534 is a continuation-in-part of application No. 16/718,906, filed on Dec. 18, 2019.
Application No. 16/718,906 is a continuation of application No. 15/879,182, filed on Jan. 24, 2018, now Pat. No. 10,514,954.
Application No. 15/879,182 is a continuation-in-part of application No. 15/850,037, filed on Dec. 21, 2017.
Application No. 15/850,037 is a continuation-in-part of application No. 15/489,716, filed on Apr. 17, 2017.
Application No. 15/489,716 is a continuation-in-part of application No. 15/409,510, filed on Jan. 18, 2017.
Application No. 15/409,510 is a continuation-in-part of application No. 15/931,534, filed on May 13, 2020.
Application No. 15/931,534 is a continuation-in-part of application No. 15/905,041, filed on Feb. 26, 2018, now Pat. No. 10,706,063.
Application No. 15/905,041 is a continuation-in-part of application No. 15/237,625, filed on Aug. 15, 2016, now Pat. No. 10,248,910.
Application No. 15/237,625 is a continuation-in-part of application No. 15/931,534, filed on May 13, 2020.
Application No. 15/931,534 is a continuation-in-part of application No. 16/191,054, filed on Nov. 14, 2018, now Pat. No. 10,681,074.
Application No. 16/191,054 is a continuation-in-part of application No. 15/655,113, filed on Jul. 20, 2017, now Pat. No. 10,735,456.
Application No. 15/655,113 is a continuation-in-part of application No. 15/931,534, filed on May 13, 2020.
Application No. 15/931,534 is a continuation-in-part of application No. 16/654,309, filed on Oct. 16, 2019.
Application No. 16/654,309 is a continuation-in-part of application No. 15/847,443, filed on Dec. 19, 2017.
Application No. 15/847,443 is a continuation-in-part of application No. 15/790,457, filed on Oct. 23, 2017, now Pat. No. 10,884,999.
Application No. 15/790,457 is a continuation-in-part of application No. 15/790,327, filed on Oct. 23, 2017, now Pat. No. 10,860,951.
Application No. 15/790,327 is a continuation-in-part of application No. 15/616,427, filed on Jun. 7, 2017.
Application No. 15/616,427 is a continuation-in-part of application No. 15/141,752, filed on Apr. 28, 2016, now Pat. No. 10,860,962.
Application No. 15/141,752 is a continuation-in-part of application No. 15/931,534, filed on May 13, 2020.
Application No. 15/931,534 is a continuation-in-part of application No. 16/654,309, filed on Oct. 16, 2019.
Application No. 16/654,309 is a continuation-in-part of application No. 15/847,443, filed on Dec. 19, 2017.
Application No. 15/847,443 is a continuation-in-part of application No. 15/489,716, filed on Apr. 17, 2017.
Application No. 15/489,716 is a continuation-in-part of application No. 15/616,427, filed on Jun. 7, 2017.
Application No. 15/616,427 is a continuation-in-part of application No. 14/925,974, filed on Oct. 28, 2015, now abandoned.
Application No. 14/925,974 is a continuation-in-part of application No. 15/931,534, filed on May 13, 2020.
Application No. 15/931,534 is a continuation-in-part of application No. 16/660,727, filed on Oct. 22, 2019, now Pat. No. 10,938,683.
Application No. 16/660,727 is a continuation of application No. 15/229,476, filed on Aug. 5, 2016, now Pat. No. 10,454,791.
Application No. 15/229,476 is a continuation-in-part of application No. 15/206,195, filed on Jul. 8, 2016.
(60) Provisional application No. 62/568,298, filed on Oct. 4, 2017.
(60) Provisional application No. 62/568,291, filed on Oct. 4, 2017.
(60) Provisional application No. 62/568,305, filed on Oct. 4, 2017.
(60) Provisional application No. 62/568,312, filed on Oct. 4, 2017.
(60) Provisional application No. 62/568,298, filed on Oct. 4, 2017.
(60) Provisional application No. 62/568,291, filed on Oct. 4, 2017.

(51) Int. Cl. H04L 29/06; G06F 16/951; G06F 16/2458

(52) U.S. Cl. CPC H04L 63/20; H04L 63/1425; H04L 63/1441; G06F 16/2477; G06F 16/951

(57) ABSTRACT

A system and method for universalization and contextualization of computing assets that utilizes structure, organization, and ontologically-related metadata to unify computing assets into a common data model combined with provenance-related metadata to contextualize the assets for suitability in a given situation. The system and method include an asset registry that contains provenance information and ontological information about available computing assets, a provenance manager which tracks the provenance of each asset for data validation and contextual analysis purposes, an ontology manager that uses ontological relationships among assets to determine other domains in which an asset may be useful, and an interoperability manager which combines the provenance and ontology outputs to suggest computing assets that may be useful in a given context.

### CROSS-REFERENCE TO RELATED APPLICATIONS

| Application | | |
|---|---|---|
| No. | Date Filed | Title |
| Current | Herewith | UNIVERSAL COMPUTING ASSET |
| application | | REGISTRY |
| | | Is a continuation-in-part: |
| 16/864,133 | Apr. 30, 2020 | MULTI-TENANT KNOWLEDGE GRAPH |
| | | DATABASES WITH DYNAMIC |
| | | SPECIFICATION AND ENFORCEMENT |
| | | OF ONTOLOGICAL DATA MODELS |
| | | which is a continuation-in-part of: |
| 15/847,443 | Dec. 19, 2017 | SYSTEM AND METHOD FOR |
| | | AUTOMATIC CREATION OF |
| | | ONTOLOGICAL DATABASES AND |
| | | SEMANTIC SEARCHING |
| | | which is a continuation-in-part of: |
| 15/790,457 | Oct. 23, 2017 | DISTRIBUTABLE MODEL WITH BIASES |
| | | CONTAINED WITHIN DISTRIBUTED |
| | | DATA |
| | | which claims benefit of, and priority to: |
| 62/568,298 | Oct. 4, 2017 | DISTRIBUTABLE MODEL WITH BIASES |
| | | CONTAINED IN DISTRIBUTED DATA |
| | | and is also a continuation-in-part of: |
| 15/790,327 | Oct. 23, 2017 | DISTRIBUTABLE MODEL WITH |
| | | DISTRIBUTED DATA |
| | | which claims benefit of, and priority to: |
| 62/568,291 | Oct. 4, 2017 | DISTRIBUTABLE MODEL WITH |
| | | DISTRIBUTED DATA |
| | | and is also a continuation-in-part of: |
| 15/616,427 | Jun. 7, 2017 | RAPID PREDICTIVE ANALYSIS OF VERY |
| | | LARGE DATA SETS USING AN ACTOR- |
| | | DRIVEN DISTRIBUTED |
| | | COMPUTATIONAL GRAPH |
| | | and is also a continuation-in-part of: |
| 15/141,752 | Apr. 28, 2016 | SYSTEM FOR FULLY INTEGRATED |
| | | CAPTURE, AND ANALYSIS OF BUSINESS |
| | | INFORMATION RESULTING IN |
| | | PREDICTIVE DECISION MAKING AND |
| | | SIMULATION |
| | | which is a continuation-in-part of: |
| 15/091,563 | Apr. 5, 2016 | SYSTEM FOR CAPTURE, ANALYSIS AND |
| Patent | Issue Date | STORAGE OF TIME SERIES DATA FROM |
| 10,204,147 | Feb. 12, 2019 | SENSORS WITH HETEROGENEOUS |
| | | REPORT INTERVAL PROFILES |
| | | and is also a continuation-in-part of: |
| 14/986,536 | Dec. 31, 2015 | DISTRIBUTED SYSTEM FOR LARGE |
| Patent | Issue Date | VOLUME DEEP WEB DATA |
| 10,210,255 | Feb. 19, 2019 | EXTRACTION |
| | | and is also a continuation-in-part of: |
| 14/925,974 | Oct. 28, 2015 | RAPID PREDICTIVE ANALYSIS OF VERY |
| | | LARGE DATA SETS USING THE |
| | | DISTRIBUTED COMPUTATIONAL |
| | | GRAPH |
| Current | Herewith | UNIVERSAL COMPUTING ASSET |
| application | | REGISTRY |
| | | Is a continuation-in-part of: |
| 16/864,133 | Apr. 30, 2020 | MULTI-TENANT KNOWLEDGE GRAPH |
| | | DATABASES WITH DYNAMIC |
| | | SPECIFICATION AND ENFORCEMENT |
| | | OF ONTOLOGICAL DATA MODELS |
| | | which is a continuation-in-part of: |
| 15/847,443 | Dec. 19, 2017 | SYSTEM AND METHOD FOR |
| | | AUTOMATIC CREATION OF |
| | | ONTOLOGICAL DATABASES AND |
| | | SEMANTIC SEARCHING |
| | | which is a continuation-in-part of: |
| 15/616,427 | Jun. 7, 2017 | RAPID PREDICTIVE ANALYSIS OF VERY |
| | | LARGE DATA SETS USING AN ACTOR- |
| | | DRIVEN DISTRIBUTED |
| | | COMPUTATIONAL GRAPH |
| | | which is a continuation-in-part of: |
| 14/925,974 | Oct. 28, 2015 | RAPID PREDICTIVE ANALYSIS OF VERY |
| | | LARGE DATA SETS USING THE |
| | | DISTRIBUTED COMPUTATIONAL |
| | | GRAPH |
| Current | Herewith | UNIVERSAL COMPUTING ASSET |
| application | | REGISTRY |
| | | Is a continuation-part-of: |
| 16/864,133 | Apr. 30, 2020 | MULTI-TENANT KNOWLEDGE GRAPH |
| | | DATABASES WITH DYNAMIC |
| | | SPECIFICATION AND ENFORCEMENT |
| | | OF ONTOLOGICAL DATA MODELS |
| | | which is a continuation-in-part of: |
| 15/847,443 | Dec. 19, 2017 | SYSTEM AND METHOD FOR |
| | | AUTOMATIC CREATION OF |
| | | ONTOLOGICAL DATABASES AND |
| | | SEMANTIC SEARCHING |
| | | which is a continuation-in-part of: |
| 15/489,716 | Apr. 17, 2017 | REGULATION BASED SWITCHING |
| | | SYSTEM FOR ELECTRONIC MESSAGE |
| | | ROUTING |
| | | which is a continuation-in-part of: |
| 15/409,510 | Jan. 18, 2017 | MULTI-CORPORATION VENTURE PLAN |
| | | VALIDATION EMPLOYING AN |
| | | ADVANCED DECISION PLATFORM |
| | | which is a continuation-in-part of: |
| 15/379,899 | Dec. 15, 2016 | INCLUSION OF TIME SERIES |
| | | GEOSPATIAL MARKERS IN ANALYSES |
| | | EMPLOYING AN ADVANCED CYBER- |
| | | DECISION PLATFORM |
| | | which is a continuation-in-part of: |
| 15/376,657 | Dec. 13, 2016 | QUANTIFICATION FOR INVESTMENT |
| Patent | Issue Date | VEHICLE MANAGEMENT EMPLOYING |
| 10,402,906 | Sep. 3, 2019 | AN ADVANCED DECISION PLATFORM |
| | | which is a continuation-in-part of: |
| 15/237,625 | Aug. 15, 2016 | DETECTION MITIGATION AND |
| Patent | | REMEDIATION OF CYBERATTACKS |
| 10,248,910 | Issue Date | EMPLOYING AN ADVANCED CYBER- |
| | Apr. 2, 2019 | DECISION PLATFORM |
| | | which is a continuation-in-part of: |
| 15/206,195 | Jul. 8, 2016 | ACCURATE AND DETAILED MODELING |
| | | OF SYSTEMS WITH LARGE COMPLEX |
| | | DATASETS USING A DISTRIBUTED |
| | | SIMULATION ENGINE |
| | | which is a continuation-in-part of: |
| 15/186,453 | Jun. 18, 2016 | SYSTEM FOR AUTOMATED CAPTURE |
| | | AND ANALYSIS OF BUSINESS |
| | | INFORMATION FOR RELIABLE |
| | | BUSINESS VENTURE OUTCOME |
| | | PREDICTION |
| | | which is a continuation-in-part of: |
| 15/166,158 | May 26, 2016 | SYSTEM FOR AUTOMATED CAPTURE |
| | | AND ANALYSIS OF BUSINESS |
| | | INFORMATION FOR SECURITY AND |
| | | CLIENT-FACING INFRASTRUCTURE |
| | | RELIABILITY |
| | | which is a continuation-in-part of: |
| 15/141,752 | Apr. 28, 2016 | SYSTEM FOR FULLY INTEGRATED |
| | | CAPTURE, AND ANALYSIS OF BUSINESS |
| | | INFORMATION RESULTING IN |
| | | PREDICTIVE DECISION MAKING AND |
| | | SIMULATION |
| Current | Herewith | UNIVERSAL COMPUTING ASSET |
| application | | REGISTRY |
| | | Is a continuation-part-of: |
| 16/915,176 | Jun. 29, 2020 | RISK PROFILING AND RATING OF |
| | | EXTENDED RELATIONSHIPS USING |
| | | ONTOLOGICAL DATABASES |
| | | which is a continuation-in-part of: |
| 15/847,443 | Dec. 19, 2017 | SYSTEM AND METHOD FOR |
| | | AUTOMATIC CREATION OF |
| | | ONTOLOGICAL DATABASES AND |
| | | SEMANTIC SEARCHING |
| Current | Herewith | UNIVERSAL COMPUTING ASSET |
| application | | REGISTRY |
| | | Is a continuation-part-of: |
| 16/915,176 | Jun. 29, 2020 | RISK PROFILING AND RATING OF |
| | | EXTENDED RELATIONSHIPS USING |
| | | ONTOLOGICAL DATABASES |
| | | which is a continuation-in-part of: |
| 15/891,329 | Feb. 7, 2018 | AUTOMATED VISUAL INFORMATION |
| | | CONTEXT AND MEANING |
| | | COMPREHENSION SYSTEM |
| | | which is a continuation-in-part of: |
| 15/860,980 | Jan. 3, 2018 | COLLABORATIVE ALGORITHM |
| | | DEVELOPMENT, DEPLOYMENT, AND |
| | | TUNING PLATFORM |
| | | which is a continuation-in-part of: |
| 15/850,037 | Dec. 21, 2017 | ADVANCED DECENTRALIZED |
| | | FINANCIAL DECISION PLATFORM |
| | | which is a continuation-in-part of: |
| 15/673,368 | Aug. 9, 2017 | AUTOMATED SELECTION AND |
| | | PROCESSING OF FINANCIAL MODELS |
| | | which is a continuation-in-part of: |
| 15/376,657 | Dec. 13, 2016 | QUANTIFICATION FOR INVESTMENT |
| Patent | Issue Date | VEHICLE MANAGEMENT EMPLOYING |
| 10,402,906 | Sep. 3, 2019 | AN ADVANCED DECISION PLATFORM |
| Current | Herewith | UNIVERSAL COMPUTING ASSET |
| application | | REGISTRY |
| | | Is a continuation-part-of: |
| 16/915,176 | Jun. 29, 2020 | RISK PROFILING AND RATING OF |
| | | EXTENDED RELATIONSHIPS USING |
| | | ONTOLOGICAL DATABASES |
| | | which is a continuation-in-part of: |
| 15/891,329 | Feb. 7, 2018 | AUTOMATED VISUAL INFORMATION |
| | | CONTEXT AND MEANING |
| | | COMPREHENSION SYSTEM |
| | | which is a continuation-in-part of: |
| 15/860,980 | Jan. 3, 2018 | COLLABORATIVE ALGORITHM |
| | | DEVELOPMENT, DEPLOYMENT, AND |
| | | TUNING PLATFORM |
| | | which is a continuation-in-part of: |
| 15/850,037 | Dec. 21, 2017 | ADVANCED DECENTRALIZED |
| | | FINANCIAL DECISION PLATFORM |
| | | which is also a continuation-in-part of: |
| 15/489,716 | Apr. 17, 2017 | REGULATION BASED SWITCHING |
| | | SYSTEM FOR ELECTRONIC MESSAGE |
| | | ROUTING |
| Current | Herewith | UNIVERSAL COMPUTING ASSET |
| application | | REGISTRY |
| | | Is a continuation-part-of: |
| 16/915,176 | Jun. 29, 2020 | RISK PROFILING AND RATING OF |
| | | EXTENDED RELATIONSHIPS USING |
| | | ONTOLOGICAL DATABASES |
| | | which is a continuation-in-part of: |
| 15/891,329 | Feb. 7, 2018 | AUTOMATED VISUAL INFORMATION |
| | | CONTEXT AND MEANING |
| | | COMPREHENSION SYSTEM |
| | | which is a continuation-in-part of: |
| 15/860,980 | Jan. 3, 2018 | COLLABORATIVE ALGORITHM |
| | | DEVELOPMENT, DEPLOYMENT, AND |
| | | TUNING PLATFORM |
| | | which is a continuation-in-part of: |
| 15/788,002 | Oct. 19, 2017 | ALGORITHM MONETIZATION AND |
| | | EXCHANGE PLATFORM |
| | | which claims priority to, and benefit of: |
| 62/568,305 | Oct. 4, 2017 | ALGORITHM MONETIZATION AND |
| | | EXCHANGE PLATFORM |
| | | and is also a continuation-in-part of: |
| 15/787,601 | Oct. 18, 2017 | METHOD AND APPARATUS FOR |
| | | CROWDSOURCED DATA GATHERING, |
| | | EXTRACTION, AND COMPENSATION |
| | | which claims priority to, and benefit of: |
| 62/568,312 | Oct. 4, 2017 | METHOD AND APPARATUS FOR |
| | | CROWDSOURCED DATA GATHERING, |
| | | EXTRACTION, AND COMPENSATION |
| | | and is also a continuation-in-part of: |
| 15/616,427 | Jun. 7, 2017 | RAPID PREDICTIVE ANALYSIS OF VERY |
| | | LARGE DATA SETS USING AN ACTOR- |
| | | DRIVEN DISTRIBUTED |
| | | COMPUTATIONAL GRAPH |
| Current | Herewith | UNIVERSAL COMPUTING ASSET |
| application | | REGISTRY |
| | | Is a continuation-part-of: |
| 16/915,176 | Jun. 29, 2020 | RISK PROFILING AND RATING OF |
| | | EXTENDED RELATIONSHIPS USING |
| | | ONTOLOGICAL DATABASES |
| | | which is a continuation-in-bart of |
| 15/905,041 | Feb. 26, 2018 | AUTOMATED SCALABLE CONTEXTUAL |
| Patent | Issue Date | DATA COLLECTION AND EXTRACTION |
| 10,706,063 | Jul. 7, 2020 | SYSTEM |
| | | which is a continuation-in-part of: |
| 15/237,625 | Aug. 15, 2016 | DETECTION MITIGATION AND |
| Patent | Issue Date | REMEDIATION OF CYBERATTACKS |
| 10,248,910 | Apr. 2, 2019 | EMPLOYING AN ADVANCED CYBER- |
| | | DECISION PLATFORM |
| Current | Herewith | SYSTEM FOR THE PRIORITIZATION |
| application | | AND DYNAMIC PRESENTATION OF |
| | | DIGITAL CONTENT |
| | | Is a continuation-in-part of: |
| 15/931,534 | May 13, 2020 | SECURE POLICY-CONTROLLED |
| | | PROCESSING AND AUDITING ON |
| | | REGULATED DATA SETS |
| | | which is a continuation-in-part of: |
| 16/777,270 | Jan. 30, 2020 | CYBERSECURITY PROFILING AND |
| | | RATING USING ACTIVE AND PASSIVE |
| | | EXTERNAL RECONNAISSANCE |
| | | which is a continuation-in-part of: |
| 16/720,383 | Dec. 19, 2019 | RATING ORGANIZATION |
| | | CYBERSECURITY USING ACTIVE AND |
| | | PASSIVE EXTERNAL RECONNAISSANCE |
| | | which is a continuation of: |
| 15/823,363 | Nov. 27, 2017 | RATING ORGANIZATION |
| Patent | Issue Date | CYBERSECURITY USING ACTIVE AND |
| 10,560,483 | Feb. 11, 2020 | PASSIVE EXTERNAL RECONNAISSANCE |
| | | which is a continuation-in-part of: |
| 15/725,274 | Oct. 4, 2017 | APPLICATION OF ADVANCED |
| Patent | Issue Date | CYBERSECURITY THREAT MITIGATION |
| 10,609,079 | Mar. 31, 2020 | TO ROGUE DEVICES, PRIVILEGE |
| | | ESCALATION, AND RISK-BASED |
| | | VULNERABILITY AND PATCH |
| | | MANAGEMENT |
| | | which is a continuation-in-part of: |
| 15/655,113 | Jul. 20, 2017 | ADVANCED CYBERSECURITY THREAT |
| | | MITIGATION USING BEHAVIORAL AND |
| | | DEEP ANALYTICS |
| | | which is a continuation-in-part of: |
| 15/616,427 | Jun. 7, 2017 | RAPID PREDICTIVE ANALYSIS OF VERY |
| | | LARGE DATA SETS USING AN ACTOR- |
| | | DRIVEN DISTRIBUTED |
| | | COMPUTATIONAL GRAPH |
| | | which is a continuation-in-part of: |
| 14/925,974 | Oct. 28, 2015 | RAPID PREDICTIVE ANALYSIS OF VERY |
| | | LARGE DATA SETS USING THE |
| | | DISTRIBUTED COMPUTATIONAL |
| | | GRAPH |
| Current | Herewith | CYBERSECURITY PROFILING AND |
| application | | RATING USING ACTIVE AND PASSIVE |
| | | EXTERNAL RECONNAISSANCE |
| | | Is a continuation-in-part of: |
| 15/931,534 | May 13, 2020 | SECURE POLICY-CONTROLLED |
| | | PROCESSING AND AUDITING ON |
| | | REGULATED DATA SETS |
| | | which is a continuation-in-part of: |
| 16/777,270 | Jan. 30, 2020 | CYBERSECURITY PROFILING AND |
| | | RATING USING ACTIVE AND PASSIVE |
| | | EXTERNAL RECONNAISSANCE |
| | | which is a continuation-in-part of: |
| 16/720,383 | Dec. 19, 2019 | RATING ORGANIZATION |
| | | CYBERSECURITY USING ACTIVE AND |
| | | PASSIVE EXTERNAL RECONNAISSANCE |
| | | which is a continuation of: |
| 15/823,363 | Nov. 27, 2017 | RATING ORGANIZATION |
| Patent | Issue Date | CYBERSECURITY USING ACTIVE AND |
| 10,560,483 | Feb. 11, 2020 | PASSIVE EXTERNAL RECONNAISSANCE |
| | | which is a continuation-in-part of: |
| 15/725,274 | Oct. 4, 2017 | APPLICATION OF ADVANCED |
| Patent | Issue Date | CYBERSECURITY THREAT MITIGATION |
| 10,609,079 | Mar. 31, 2020 | TO ROGUE DEVICES, PRIVILEGE |
| | | ESCALATION, AND RISK-BASED |
| | | VULNERABILITY AND PATCH |
| | | MANAGEMENT |
| | | which is a continuation-in-part of: |
| 15/655,113 | Jul. 20, 2017 | ADVANCED CYBERSECURITY THREAT |
| | | MITIGATION USING BEHAVIORAL AND |
| | | DEEP ANALYTICS |
| | | which is also a continuation-in-part of: |
| 15/237,625 | Aug. 15, 2016 | DETECTION MITIGATION AND |
| Patent | Issue Date | REMEDIATION OF CYBERATTACKS |
| 10,248,910 | Apr. 2, 2019 | EMPLOYING AN ADVANCED CYBER- |
| | | DECISION PLATFORM |
| Current | Herewith | CYBERSECURITY PROFILING AND |
| application | | RATING USING ACTIVE AND PASSIVE |
| | | EXTERNAL RECONNAISSANCE |
| | | Is a continuation-in-part of: |
| 15/931,534 | May 13, 2020 | SECURE POLICY-CONTROLLED |
| | | PROCESSING AND AUDITING ON |
| | | REGULATED DATA SETS |
| | | which is a continuation-in-part of: |
| 15/683,765 | Aug. 22, 2017 | PREDICTIVE LOAD BALANCING FOR A |
| | | DIGITAL ENVIRONMENT |
| | | which is a continuation-in-part of: |
| 15/409,510 | Jan. 18, 2017 | MULTI-CORPORATION VENTURE PLAN |
| | | VALIDATION EMPLOYING AN |
| | | ADVANCED DECISION PLATFORM |
| | | which is a continuation-in-part of: |
| 15/379,899 | Dec. 15, 2016 | INCLUSION OF TIME SERIES |
| | | GEOSPATIAL MARKERS IN ANALYSES |
| | | EMPLOYING AN ADVANCED CYBER- |
| | | DECISION PLATFORM |
| | | which is a continuation-in-part of: |
| 15/376,657 | Dec. 13, 2016 | QUANTIFICATION FOR INVESTMENT |
| Patent | Issue Date | VEHICLE MANAGEMENT EMPLOYING |
| 10,402,906 | Sep. 3, 2019 | AN ADVANCED DECISION PLATFORM |
| | | which is a continuation-in-part of: |
| 15/237,625 | Aug. 15, 2016 | DETECTION MITIGATION AND |
| Patent | Issue Date | REMEDIATION OF CYBERATTACKS |
| 10,248,910 | Apr. 2, 2019 | EMPLOYING AN ADVANCED CYBER- |
| | | DECISION PLATFORM |
| Current | Herewith | CYBERSECURITY PROFILING AND |
| application | | RATING USING ACTIVE AND PASSIVE |
| | | EXTERNAL RECONNAISSANCE |
| | | Is a continuation-in-part of: |
| 15/931,534 | May 13, 2020 | SECURE POLICY-CONTROLLED |
| | | PROCESSING AND AUDITING ON |
| | | REGULATED DATA SETS |
| | | which is a continuation-in-part of: |
| 16/718,906 | Dec. 18, 2019 | PLATFORM FOR HIERARCHY |
| | | COOPERATIVE COMPUTING |
| | | which is a continuation of: |
| 15/879,182 | Jan. 24, 2018 | PLATFORM FOR HIERARCHY |
| Patent | Issue Date | COOPERATIVE COMPUTING |
| 10,514,954 | Dec. 24, 2019 | |
| | | which is a continuation-in-part of: |
| 15/850,037 | Dec. 21, 2017 | ADVANCED DECENTRALIZED |
| | | FINANCIAL DECISION PLATFORM |
| | | which is a continuation-in-part of: |
| 15/673,368 | Aug. 9, 2017 | AUTOMATED SELECTION AND |
| | | PROCESSING OF FINANCIAL MODELS |
| | | which is a continuation-in-part of: |
| 15/376,657 | Dec. 13, 2016 | QUANTIFICATION FOR INVESTMENT |
| Patent | Issue Date | VEHICLE MANAGEMENT EMPLOYING |
| 10,402,906 | Sep. 3, 2019 | AN ADVANCED DECISION PLATFORM |
| Current | Herewith | CYBERSECURITY PROFILING AND |
| application | | RATING USING ACTIVE AND PASSIVE |
| | | EXTERNAL RECONNAISSANCE |
| | | Is a continuation-in-part of: |
| 15/931,534 | May 13, 2020 | SECURE POLICY-CONTROLLED |
| | | PROCESSING AND AUDITING ON |
| | | REGULATED DATA SETS |
| | | which is a continuation-in-part of: |
| 16/718,906 | Dec. 18, 2019 | PLATFORM FOR HIERARCHY |
| | | COOPERATIVE COMPUTING |
| | | which is a continuation of |
| 15/879,182 | Jan. 24, 2018 | PLATFORM FOR HIERARCHY |
| Patent | Issue Date | COOPERATIVE COMPUTING |
| 10,514,954 | Dec. 24, 2019 | |
| | | which is a continuation-in-part of: |
| 15/850,037 | Dec. 21, 2017 | ADVANCED DECENTRALIZED |
| | | FINANCIAL DECISION PLATFORM |
| | | which is a continuation-in-part of: |
| 15/489,716 | Apr. 17, 2017 | REGULATION BASED SWITCHING |
| | | SYSTEM FOR ELECTRONIC MESSAGE |
| | | ROUTING |
| | | which is a continuation-in-part of: |
| 15/409,510 | Jan. 18, 2017 | MULTI-CORPORATION VENTURE PLAN |
| | | VALIDATION EMPLOYING AN |
| | | ADVANCED DECISION PLATFORM |
| Current | Herewith | CYBERSECURITY PROFILING AND |
| application | | RATING USING ACTIVE AND PASSIVE |
| | | EXTERNAL RECONNAISSANCE |
| | | Is a continuation-in-part of: |
| 15/931,534 | May 13, 2020 | SECURE POLICY-CONTROLLED |
| | | PROCESSING AND AUDITING ON |
| | | REGULATED DATA SETS |
| | | which is a continuation-in-part of: |
| 15/905,041 | Feb. 28, 2018 | AUTOMATED SCALABLE CONTEXTUAL |
| Patent | Issue Date | DATA COLLECTION AND EXTRACTION |
| 10,706,063 | Jul. 7, 2020 | SYSTEM |
| | | which is a continuation-in-part of: |
| 15/237,625 | Aug. 15, 2016 | DETECTION MITIGATION AND |
| Patent | Issue Date | REMEDIATION OF CYBERATTACKS |
| 10,248,910 | Apr. 2, 2019 | EMPLOYING AN ADVANCED CYBER- |
| | | DECISION PLATFORM |
| Current | Herewith | CYBERSECURITY PROFILING AND |
| application | | RATING USING ACTIVE AND PASSIVE |
| | | EXTERNAL RECONNAISSANCE |
| | | Is a continuation-in-part of: |
| 15/931,534 | May 13, 2020 | SECURE POLICY-CONTROLLED |
| | | PROCESSING AND AUDITING ON |
| | | REGULATED DATA SETS |
| | | which is a continuation-in-part of: |
| 16/191,054 | Nov. 14, 2018 | SYSTEM AND METHOD FOR |
| Patent | Issue Date | COMPREHENSIVE DATA LOSS |
| 10,681,074 | Jun. 9, 2020 | PREVENTION AND COMPLIANCE |
| | | MANAGEMENT |
| | | which is a continuation-in-part of: |
| 15/655,113 | Jul. 20, 2017 | ADVANCED CYBERSECURITY THREAT |
| | | MITIGATION USING BEHAVIORAL AND |
| | | DEEP ANALYTICS |
| Current | Herewith | CYBERSECURITY PROFILING AND |
| application | | RATING USING ACTIVE AND PASSIVE |
| | | EXTERNAL RECONNAISSANCE |
| | | Is a continuation-in-part of: |
| 15/931,534 | May 13, 2020 | SECURE POLICY-CONTROLLED |
| | | PROCESSING AND AUDITING ON |
| | | REGULATED DATA SETS |
| | | which is a continuation-in-part of: |
| 16/654,309 | Oct. 16, 2019 | SYSTEM AND METHOD AUTOMATED |
| | | ANALYSIS OF LEGAL DOCUMENTS |
| | | WITHIN AND ACROSS SPECIFIC FIELDS |
| | | which is a continuation-in-part of: |
| 15/847,443 | Dec. 19, 2017 | SYSTEM AND METHOD FOR |
| | | AUTOMATIC CREATION OF |
| | | ONTOLOGICAL DATABASES AND |
| | | SEMANTIC SEARCHING |
| | | which is a continuation-in-part of: |
| 15/790,457 | Oct. 23, 2017 | DISTRIBUTABLE MODEL WITH BIASES |
| | | CONTAINED WITHIN DISTRIBUTED |
| | | DATA |
| | | which claims benefit of, and priority to: |
| 62/568,298 | Oct. 4, 2017 | DISTRIBUTABLE MODEL WITH BIASES |
| | | CONTAINED IN DISTRIBUTED DATA |
| | | and is also a continuation-in-part of: |
| 15/790,327 | Oct. 23, 2017 | DISTRIBUTABLE MODEL WITH |
| | | DISTRIBUTED DATA |
| | | which claims benefit of, and priority to: |
| 62/568,291 | Oct. 4, 2017 | DISTRIBUTABLE MODEL WITH |
| | | DISTRIBUTED DATA |
| | | and is also a continuation-in-part of: |
| 15/616,427 | Jun. 7, 2017 | RAPID PREDICTIVE ANALYSIS OF VERY |
| | | LARGE DATA SETS USING AN ACTOR- |
| | | DRIVEN DISTRIBUTED |
| | | COMPUTATIONAL GRAPH |
| | | and is also a continuation-in-part of: |
| 15/141,752 | Apr. 28, 2016 | SYSTEM FOR FULLY INTEGRATED |
| | | CAPTURE, AND ANALYSIS OF BUSINESS |
| | | INFORMATION RESULTING IN |
| | | PREDICTIVE DECISION MAKING AND |
| | | SIMULATION |
| Current | Herewith | CYBERSECURITY PROFILING AND |
| application | | RATING USING ACTIVE AND PASSIVE |
| | | EXTERNAL RECONNAISSANCE |
| | | Is a continuation-in-part of: |
| 15/931,534 | May 13, 2020 | SECURE POLICY-CONTROLLED |
| | | PROCESSING AND AUDITING ON |
| | | REGULATED DATA SETS |
| | | which is a continuation-in-part of: |
| 16/654,309 | Oct. 16, 2019 | SYSTEM AND METHOD AUTOMATED |
| | | ANALYSIS OF LEGAL DOCUMENTS |
| | | WITHIN AND ACROSS SPECIFIC FIELDS |
| | | which is a continuation-in-part of: |
| 15/847,443 | Dec. 19, 2017 | SYSTEM AND METHOD FOR |
| | | AUTOMATIC CREATION OF |
| | | ONTOLOGICAL DATABASES AND |
| | | SEMANTIC SEARCHING |
| | | which is a continuation-in-part of: |
| 15/489,716 | Apr. 17, 2017 | REGULATION BASED SWITCHING |
| | | SYSTEM FOR ELECTRONIC MESSAGE |
| | | ROUTING |
| | | and is also a continuation-in-part of: |
| 15/616,427 | Jun. 7, 2017 | RAPID PREDICTIVE ANALYSIS OF VERY |
| | | LARGE DATA SETS USING AN ACTOR- |
| | | DRIVEN DISTRIBUTED |
| | | COMPUTATIONAL GRAPH |
| | | which is a continuation-in-part of: |
| 14/925,974 | Oct. 28, 2015 | RAPID PREDICTIVE ANALYSIS OF VERY |
| | | LARGE DATA SETS USING AN ACTOR- |
| | | DRIVEN DISTRIBUTED |
| | | COMPUTATIONAL GRAPH |
| Current | Herewith | CYBERSECURITY PROFILING AND |
| application | | RATING USING ACTIVE AND PASSIVE |
| | | EXTERNAL RECONNAISSANCE |
| | | Is a continuation-in-part of: |
| 15/931,534 | May 13, 2020 | SECURE POLICY-CONTROLLED |
| | | PROCESSING AND AUDITING ON |
| | | REGULATED DATA SETS |
| | | which is a continuation-in-part of: |
| 16/660,727 | Oct. 22, 2019 | HIGHLY SCALABLE DISTRIBUTED |
| | | CONNECTION INTERFACE FOR DATA |
| | | CAPTURE FROM MULTIPLE NETWORK |
| | | SERVICE SOURCES |
| | | which is a continuation of: |
| 15/229,476 | Aug. 5, 2016 | HIGHLY SCALABLE DISTRIBUTED |
| Patent | Issue Date | CONNECTION INTERFACE FOR DATA |
| 10,454,791 | Oct. 22, 2019 | CAPTURE FROM MULTIPLE NETWORK |
| | | SERVICE SOURCES |
| | | which is a continuation-in-part of: |
| 15/206,195 | Jul. 8, 2016 | ACCURATE AND DETAILED MODELING |
| | | OF SYSTEMS WITH LARGE COMPLEX |
| | | DATASETS USING A DISTRIBUTED |
| | | SIMULATION ENGINE |

the entire specification of each of which is incorporated herein by reference.

### BACKGROUND OF THE INVENTION

### Field of the Invention

The disclosure relates to the field of computer databases, and more particularly to the field of use of database registries containing provenance-related and ontologically-related metadata.

### Discussion of the State of the Art

A major drawback of existing databases and registries is their inability to use database resources across domains, persistence paradigms, or outside of the use cases for which the resources were originally created. This prevents sharing of resources by other systems or users, or even identification of resources that might be useful because they were created for a different domain or use case. Another major drawback is the lack of provenance information for data in databases, which prevents the ability to validate or contextualize the data for suitability in a given situation. Further, existing databases and registries do not include data processing workflows and algorithms as part of their set of resources, thus failing to sufficiently universalize data and the computing resources and services that process those data.

What is needed is a system and method for unified contextualization of computing assets that allows for sharing of assets between systems and outside of the use case for which the resources were created.

### SUMMARY OF THE INVENTION

Accordingly, the inventor has developed a system and method for unified contextualization of computing assets that utilizes ontologically-related metadata to universalize computing assets combined with provenance-related metadata to contextualize the assets for suitability in a given situation. In a preferred embodiment, the system and method comprise an asset registry that contains provenance information and ontological information about available computing assets as well as metadata about the structure and organization of data, a provenance manager which tracks the provenance of each asset for data validation and contextual analysis purposes, an ontology manager that uses ontological relationships among assets to determine other domains in which an asset may be useful, and an interoperability manager which combines the provenance and ontology outputs to suggest computing assets that may be useful in a given context.

According to a preferred embodiment, a system for universalization of computing assets is disclosed, comprising: a computing device comprising a processor, a memory, and a non-volatile data storage device; an asset registry stored on the non-volatile data storage device, the asset registry comprising a list of computing assets with ontology metadata for each computing asset; and an asset registry manager comprising a first plurality of programming instructions stored in the memory and operating on the processor which cause the computing device to: create an ontology of computing assets using the ontology metadata; receive a computing use case selection from a user; create a list of computing assets usable for the computing use case, the list comprising computing assets that are determined to be ontologically related to the computing use case based on the ontology; and display the list of computing assets usable for the computing use case.

According to another preferred embodiment, a method for universalization of computing assets is disclosed, comprising the steps of: creating an asset registry on a non-volatile data storage device, the asset registry comprising a list of computing assets with ontology metadata for each computing asset; creating an ontology of computing assets using the ontology metadata; receiving a computing use case selection from a user; creating a list of computing assets usable for the computing use case, the list comprising computing assets that are determined to be ontologically related to the computing use case based on the ontology; for each computing asset on the list, calculating a reliability of results of the use of the computing asset for the computing use case based on the provenance metadata; and displaying the list of computing assets usable for the computing use case.

According to an aspect of an embodiment, the asset registry further comprises provenance metadata for each asset, and a provenance manager is used to: track the provenance of each computing asset using the provenance metadata; for each computing asset on the list, calculate a reliability of results of the use of the computing asset for the computing use case based on the provenance metadata; and displaying the list of computing assets usable for the computing use case with the calculated reliability of results.

According to an aspect of an embodiment, the provenance metadata for each asset further comprises bias metadata, and the reliability of results includes an analysis of the bias metadata.

According to an aspect of an embodiment, an asset marketplace is used to allow the purchase, sale, or licensing of computing assets.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 is a block diagram of an exemplary system architecture for an advanced cyber decision platform.

FIG. 2 is a block diagram of an advanced cyber decision platform in an exemplary configuration for use in investment vehicle management.

FIGS. 3A and 3B are process diagrams showing an example of how the advanced cyber decision platform functions in use to mitigate cyberattacks.

FIG. 4 is an exemplary system architecture diagram of a system for universalization and contextualization of computing assets.

FIG. 5 is an exemplary system architecture diagram of the asset registry manager aspect of a system for universalization and contextualization of computing assets.

FIG. 6 is a flow diagram showing an example of the use of provenance metadata to weight the influence of different types of data on a decision.

FIG. 7 is an exemplary data structure showing exemplary metadata fields that may be associated with a computing asset.

FIG. 8 is an exemplary provenance-ontology graph demonstrating how the ontological metadata may be converted to a directed graph and used to determine a possible use of a computing resource outside of the context in which the computing resource was created.

FIG. 9 is an exemplary client portal home page showing examples of universalized computing assets which a client may employ to solve computing needs.

FIG. 10 is a block diagram illustrating an exemplary hardware architecture of a computing device.

FIG. 11 is a block diagram illustrating an exemplary logical architecture for a client device.

FIG. 12 is a block diagram showing an exemplary architectural arrangement of clients, servers, and external services.

FIG. 13 is another block diagram illustrating an exemplary hardware architecture of a computing device.

### DETAILED DESCRIPTION

The inventor has conceived, and reduced to practice, a system and method for universalization and contextualization of computing assets that utilizes structure, organization, and ontologically-related metadata to unify computing assets into a common data model combined with provenance-related metadata to contextualize the assets for suitability in a given situation. In a preferred embodiment, the system and method comprise an asset registry that contains provenance information and ontological information about available computing assets, a provenance manager which tracks the provenance of each asset for data validation and contextual analysis purposes, an ontology manager that uses ontological relationships among assets to determine other domains in which an asset may be useful, and an interoperability manager which combines the provenance and ontology outputs to suggest computing assets that may be useful in a given context.

The system is designed to unify computing assets under a common data model available on a computing platform, such that customers of the platform can access computing assets available on the platform to satisfy their data processing needs. The computing assets comprise data resources and processing workflows that can be combined together to solve computing needs such as data analysis and decision-making in a variety of domains. The computing assets are modular (i.e., are essentially data and processing building blocks) that can be arranged to perform data processing tasks required by the client. The computing assets can be combined serially to perform a sequence of step-by-step data processing, or in parallel to perform simultaneous data processing, or both, depending on the needs of the customer.

Further, the computing assets can be combined together to perform more complex computing assets. In some embodiments, computing assets will be classified by their complexity, in which computing assets may be assigned categories or levels. For example, a fundamental or level zero computing asset would be an asset which either cannot be broken down into smaller components or is impractical to break into smaller components, such as a database containing a parts list for a particular make, model, and year of a car, or a processing workflow that performs a Fourier transform of signal data. The next higher order of complexity (e.g., a level one computing asset) might be a database containing a parts list for a particular make and model of a car for all years, or a simple serial processing workflow that first performs a Fourier transform of a signal and then identifies the primary three frequencies that make up the signal. The next higher order of complexity (e.g., a level two computing asset) might be a database containing a parts list for a particular make of car and all models and years, or a serial processing workflow that first performs a Fourier transform of a signal, identifies the primary three frequencies that make up the signal, and then calculates a standard deviation of the amplitude of each signal from some expected signal distribution.

In order to universalize the computing assets, the system keeps an asset registry of all assets available on the platform. The asset registry keeps track of all metadata associated with each asset to categorize the asset and determine interoperability with other assets available on the platform and may further keep additional metadata separate from each asset. Categorization metadata may include such information as asset descriptions, whether the asset is a data resource or a processing workflow, the type or data or workflow, the level or complexity of the asset, the use case for which the data or workflow was developed, and other information useful for categorizing the assets.

The metadata tracked by the asset registry may include provenance information for each asset which may include such information as who created the asset, when the asset was created, asset source type information, where the asset is located or stored, ownership, licensing, pricing and royalty information, data validation, schema, compliance and auditing information, trustworthiness scores, re-use, expiration and staleness, and known or suspected biases associated with the asset. This provenance information can be used to determine a suitability, reliability, or trustworthiness of the asset or of outputs of workflows associated with an asset.

The metadata tracked by the asset registry may include ontology information for each asset which may include such information as a domain or use for which the asset was created, similar and related domains and uses to which the asset has been successfully applied, and other ontological relationship information such as categorization (as described above), key words, domain relationships, industry relationships and overlaps, business and customer relationships, data processing similarities, and data type similarities. This ontological information can be used to determine the suitability of use of an assert in a given domain which may be different from the domain for which the asset was created, and to determine interoperability of assets created by different entities, for different purposes, or in different contexts.

A combination of the above features allows for contextual universalization of computing assets across different aspects of a platform, such that customers using the platform can search for, select, and use computing assets appropriate to their computing needs. Some examples of computing assets that may be universalized in this manner include datasets, data feeds and streams, data stores or databases; stored queries schemas, indices, ontologies; connector workflows, data transformation workflows, and data processing workflows; data sources and sinks, data collectors and actuators; plugins for application programming interfaces (APIs) or cloud-based services or microservices; models, algorithms, and simulations; rules, scratchpads, reports, notes, and forms. At lower levels of complexity, such computing assets may be very simple, such as a real-time data stream from an air temperature sensor. At higher levels of complexity, simpler assets can be combined to obtain more complex information, such as combining the data stream from the air temperature sensor with a model of a greenhouse to predict internal temperatures within the greenhouse. Using ontologies, the same sensor and model may be used in a different domain to predict the internal temperature of a car, albeit with greater uncertainty which can be reflected into ontological relationships.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

“Computing asset” or “asset” as used herein means a discretely-identifiable computing resource that may be used alone or in conjunction with our such resources to provide computing solutions. Assets may include, but are not limited to datasets, data feeds or streams, data stores or databases, stored queries, schemas, indices, ontologies, plugins, workflows, processes, algorithms, models, simulations, rules, notes, reports, forms, applications, programs, and data-processing services. Computer hardware is included in this definition where the hardware is configured to perform a discretely-identifiable data processing function.

“Graph” as used herein means a representation of information and relationships, where each primary unit of information makes up a “node” or “vertex” of the graph and the relationship between two nodes makes up an edge of the graph. Nodes can be further qualified by the connection of one or more descriptors or “properties” to that node. For example, given the node “James R,” name information for a person, qualifying properties might be “183 cm tall,” “DOB Aug. 13, 1965” and “speaks English”. Similar to the use of properties to further describe the information in a node, a relationship between two nodes that forms an edge can be qualified using a “label”. Thus, given a second node “Thomas G,” an edge between lames R″ and “Thomas G” that indicates that the two people know each other might be labeled “knows.” When graph theory notation (Graph=(Vertices, Edges)) is applied this situation, the set of nodes are used as one parameter of the ordered pair, V and the set of 2 element edge endpoints are used as the second parameter of the ordered pair, E. When the order of the edge endpoints within the pairs of E is not significant, for example, the edge James R, Thomas G is equivalent to Thomas G, James R, the graph is designated as “undirected.” Under circumstances when a relationship flows from one node to another in one direction, for example James R is “taller” than Thomas G, the order of the endpoints is significant. Graphs with such edges are designated as “directed.” In the distributed computational graph system, transformations within transformation pipeline are represented as directed graph with each transformation comprising a node and the output messages between transformations comprising edges. Distributed computational graph stipulates the potential use of non-linear transformation pipelines which are programmatically linearized. Such linearization can result in exponential growth of resource consumption. The most sensible approach to overcome possibility is to introduce new transformation pipelines just as they are needed, creating only those that are ready to compute. Such method results in transformation graphs which are highly variable in size and node, edge composition as the system processes data streams. Those familiar with the art will realize that transformation graph may assume many shapes and sizes with a vast topography of edge relationships. The examples given were chosen for illustrative purposes only and represent a small number of the simplest of possibilities. These examples should not be taken to define the possible graphs expected as part of operation of the invention.

“Ontology” as used herein refers to a formal naming and definition of the types, properties, and interrelationships of the entities that exist in a particular domain of discourse. Ontologies are a method of classification of things and their relationships with other things. They are related to, but more flexible than, taxonomies, hierarchies, and class definitions. The term ontologies, as used herein, has the meaning associated with information and computer science, rather than the definition used in philosophy of classifying things as they exist in reality.

“Domain-specific ontology” as used herein refers to the meaning of a concept within a particular ontological domain (i.e., a set of reference ideas that establishes context). For example, the word “card” has many different meanings, depending on the ontological domain (context) in which it is used. In the domain of poker, the term “card” would refer to a “playing card” as used in playing the game of poker. In the domain of computer software, the term “card” may refer to the antiquated “punch card” form of information storage. In the domain of computer hardware, the term “card” could refer to a “video card”, an “SD card” (a type of memory storage device), or similar pieces of hardware.

“Provenance” or “data provenance” as used herein means the tracking of the history or status of a computing asset, and may include any information useful for describing the history or status including, but not limited to, information about the origin, ownership, custody, transfer, access, licensing, validity, trustworthiness, and bias associated with the data.

### Conceptual Architecture

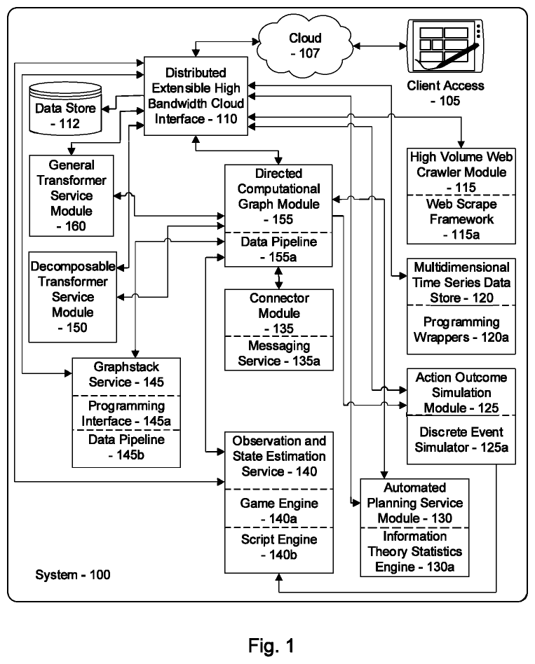

FIG. 1 is a block diagram of an advanced cyber decision platform (ACDP) for external network reconnaissance and cybersecurity rating. Client access to the system 105 for specific data entry, system control and for interaction with system output such as automated predictive decision making and planning and alternate pathway simulations, occurs through the system's distributed, extensible high bandwidth cloud interface 110 which uses a versatile, robust web application driven interface for both input and display of client-facing information via network 107 and operates a data store 112 such as, but not limited to MONGODB™, COUCHDB™, CASSANDRA™ or REDIS™ according to various arrangements. Much of the business data analyzed by the system both from sources within the confines of the client business, and from cloud based sources, also enter the system through the cloud interface 110, data being passed to the connector module 135 which may possess the API routines 135a needed to accept and convert the external data and then pass the normalized information to other analysis and transformation components of the system, the directed computational graph module 155, high volume web crawler module 115, multidimensional time series database (MDTSDB) 120 and the graph stack service 145. The directed computational graph module 155 retrieves one or more streams of data from a plurality of sources, which includes, but is in no way not limited to, a plurality of physical sensors, network service providers, web based questionnaires and surveys, monitoring of electronic infrastructure, crowd sourcing campaigns, and human input device information. Within the directed computational graph module 155, data may be split into two identical streams in a specialized pre-programmed data pipeline 155a, wherein one sub-stream may be sent for batch processing and storage while the other sub-stream may be reformatted for transformation pipeline analysis. The data is then transferred to the general transformer service module 160 for linear data transformation as part of analysis or the decomposable transformer service module 150 for branching or iterative transformations that are part of analysis. The directed computational graph module 155 represents all data as directed graphs where the transformations are nodes and the result messages between transformations edges of the graph. The high volume web crawling module 115 uses multiple server hosted preprogrammed web spiders, which while autonomously configured are deployed within a web scraping framework 115a of which SCRAPY™ is an example, to identify and retrieve data of interest from web based sources that are not well tagged by conventional web crawling technology. The multiple dimension time series data store module 120 may receive streaming data from a large plurality of sensors that may be of several different types. The multiple dimension time series data store module may also store any time series data encountered by the system such as but not limited to enterprise network usage data, component and system logs, performance data, network service information captures such as, but not limited to news and financial feeds, and sales and service related customer data. The module is designed to accommodate irregular and high volume surges by dynamically allotting network bandwidth and server processing channels to process the incoming data. Inclusion of programming wrappers 120a for languages examples of which are, but not limited to C++, PERL, PYTHON, and ERLANG™ allows sophisticated programming logic to be added to the default function of the multidimensional time series database 120 without intimate knowledge of the core programming, greatly extending breadth of function. Data retrieved by the multidimensional time series database (MDTSDB) 120 and the high volume web crawling module 115 may be further analyzed and transformed into task optimized results by the directed computational graph 155 and associated general transformer service 150 and decomposable transformer service 160 modules. Alternately, data from the multidimensional time series database and high volume web crawling modules may be sent, often with scripted cuing information determining important vertexes 145a, to the graph stack service module 145 which, employing standardized protocols for converting streams of information into graph representations of that data, for example, open graph internet technology although the invention is not reliant on any one standard. Through the steps, the graph stack service module 145 represents data in graphical form influenced by any pre-determined scripted modifications 145a and stores it in a graph-based data store 145b such as GIRAPH™ or a key value pair type data store REDIS™, or RIAK™, among others, all of which are suitable for storing graph-based information.

Results of the transformative analysis process may then be combined with further client directives, and additional business rules and practices relevant to the analysis and situational information external to the already available data in the automated planning service module 130 which also runs powerful information theory 130a based predictive statistics functions and machine learning algorithms to allow future trends and outcomes to be rapidly forecast based upon the current system derived results and choosing each a plurality of possible business decisions. The using all available data, the automated planning service module 130 may propose business decisions most likely to result is the most favorable business outcome with a usably high level of certainty. Closely related to the automated planning service module in the use of system derived results in conjunction with possible externally supplied additional information in the assistance of end user business decision making, the action outcome simulation module 125 with its discrete event simulator programming module 125a coupled with the end user facing observation and state estimation service 140 which is highly scriptable 140b as circumstances require and has a game engine 140a to more realistically stage possible outcomes of business decisions under consideration, allows business decision makers to investigate the probable outcomes of choosing one pending course of action over another based upon analysis of the current available data.

When performing external reconnaissance via a network 107, web crawler 115 may be used to perform a variety of port and service scanning operations on a plurality of hosts. This may be used to target individual network hosts (for example, to examine a specific server or client device) or to broadly scan any number of hosts (such as all hosts within a particular domain, or any number of hosts up to the complete IPv4 address space). Port scanning is primarily used for gathering information about hosts and services connected to a network, using probe messages sent to hosts that prompt a response from that host. Port scanning is generally centered around the transmission control protocol (TCP), and using the information provided in a prompted response a port scan can provide information about network and application layers on the targeted host.

Port scan results can yield information on open, closed, or undetermined ports on a target host. An open port indicated that an application or service is accepting connections on this port (such as ports used for receiving customer web traffic on a web server), and these ports generally disclose the greatest quantity of useful information about the host. A closed port indicates that no application or service is listening for connections on that port, and still provides information about the host such as revealing the operating system of the host, which may discovered by fingerprinting the TCP/IP stack in a response. Different operating systems exhibit identifiable behaviors when populating TCP fields, and collecting multiple responses and matching the fields against a database of known fingerprints makes it possible to determine the OS of the host even when no ports are open. An undetermined port is one that does not produce a requested response, generally because the port is being filtered by a firewall on the host or between the host and the network (for example, a corporate firewall behind which all internal servers operate).

Scanning may be defined by scope to limit the scan according to two dimensions, hosts and ports. A horizontal scan checks the same port on multiple hosts, often used by attackers to check for an open port on any available hosts to select a target for an attack that exploits a vulnerability using that port. This type of scan is also useful for security audits, to ensure that vulnerabilities are not exposed on any of the target hosts. A vertical scan defines multiple ports to examine on a single host, for example a “vanilla scan” which targets every port of a single host, or a “strobe scan” that targets a small subset of ports on the host. This type of scan is usually performed for vulnerability detection on single systems, and due to the single-host nature is impractical for large network scans. A block scan combines elements of both horizontal and vertical scanning, to scan multiple ports on multiple hosts. This type of scan is useful for a variety of service discovery and data collection tasks, as it allows a broad scan of many hosts (up to the entire Internet, using the complete IPv4 address space) for a number of desired ports in a single sweep.

Large port scans involve quantitative research, and as such may be treated as experimental scientific measurement and are subject to measurement and quality standards to ensure the usefulness of results. To avoid observational errors during measurement, results must be precise (describing a degree of relative proximity between individual measured values), accurate (describing relative proximity of measured values to a reference value), preserve any metadata that accompanies the measured data, avoid misinterpretation of data due to faulty measurement execution, and must be well-calibrated to efficiently expose and address issues of inaccuracy or misinterpretation. In addition to these basic requirements, large volumes of data may lead to unexpected behavior of analysis tools, and extracting a subset to perform initial analysis may help to provide an initial overview before working with the complete data set. Analysis should also be reproducible, as with all experimental science, and should incorporate publicly-available data to add value to the comprehensibility of the research as well as contributing to a “common framework” that may be used to confirm results.

When performing a port scan, web crawler 115 may employ a variety of software suitable for the task, such as Nmap, ZMap, or masscan. Nmap is suitable for large scans as well as scanning individual hosts, and excels in offering a variety of diverse scanning techniques. ZMap is a newer application and unlike Nmap (which is more general-purpose), ZMap is designed specifically with Internet-wide scans as the intent. As a result, ZMap is far less customizable and relies on horizontal port scans for functionality, achieving fast scan times using techniques of probe randomization (randomizing the order in which probes are sent to hosts, minimizing network saturation) and asynchronous design (utilizing stateless operation to send and receive packets in separate processing threads). Masscan uses the same asynchronous operation model of ZMap, as well as probe randomization. In masscan however, a certain degree of statistical randomness is sacrificed to improve computation time for large scans (such as when scanning the entire IPv4 address space), using the BlackRock algorithm. This is a modified implementation of symmetric encryption algorithm DES, with fewer rounds and modulo operations in place of binary ones to allow for arbitrary ranges and achieve faster computation time for large data sets.

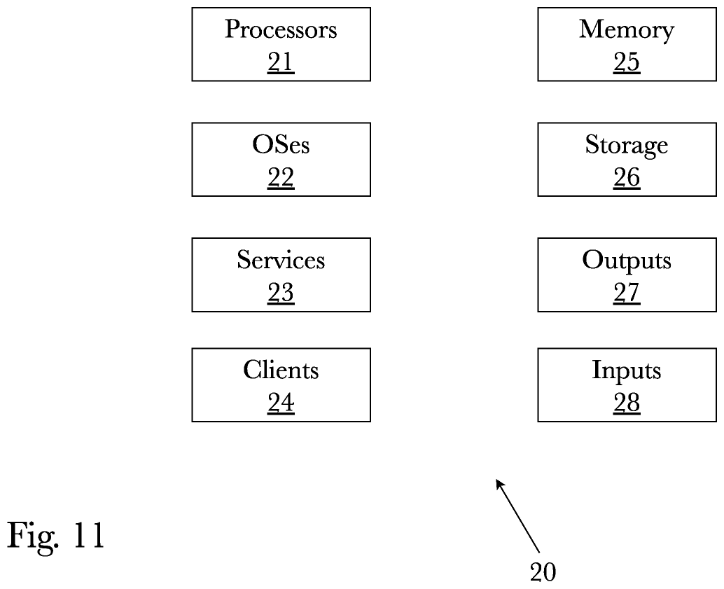

Received scan responses may be collected and processed through a plurality of data pipelines 155a to analyze the collected information. MDTSDB 120 and graph stack 145 may be used to produce a hybrid graph/time-series database using the analyzed data, forming a graph of Internet-accessible organization resources and their evolving state information over time. Customer-specific profiling and scanning information may be linked to CPG graphs (as described below in detail, referring to FIG. 11) for a particular customer, but this information may be further linked to the base-level graph of internet-accessible resources and information. Depending on customer authorizations and legal or regulatory restrictions and authorizations, techniques used may involve both passive, semi-passive and active scanning and reconnaissance.

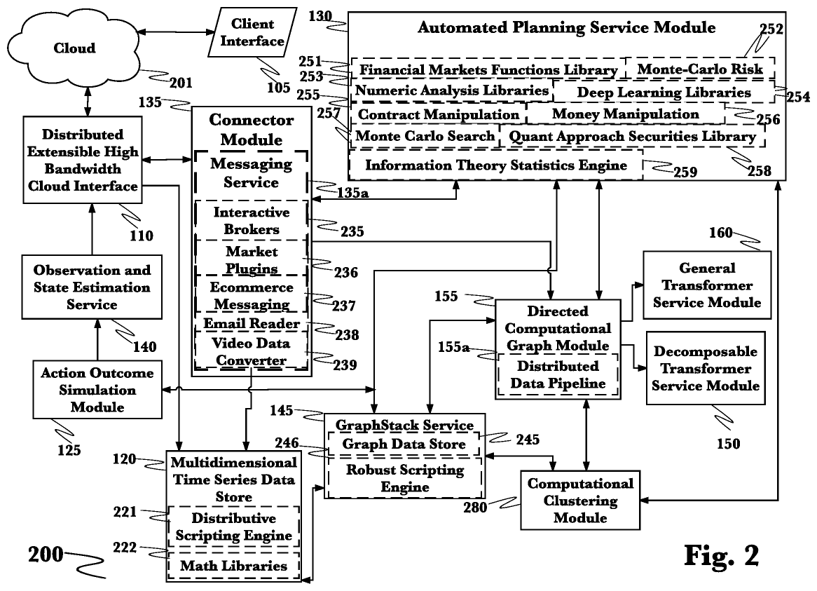

FIG. 2 is a block diagram of an advanced cyber decision platform in an exemplary configuration for use in investment vehicle management 200. The advanced cyber decision platform 100 previously disclosed in co-pending application Ser. No. 15/141,752 and applied in a role of cybersecurity in co-pending application Ser. No. 15/237,625, when programmed to operate as quantitative trading decision platform, is very well suited to perform advanced predictive analytics and predictive simulations 202 to produce investment predictions. Much of the trading specific programming functions are added to the automated planning service module 130 of the modified advanced cyber decision platform 100 to specialize it to perform trading analytics. Specialized purpose libraries may include but are not limited to financial markets functions libraries 251, Monte-Carlo risk routines 252, numeric analysis libraries 253, deep learning libraries 254, contract manipulation functions 255, money handling functions 256, Monte-Carlo search libraries 257, and quant approach securities routines 258. Pre-existing deep learning routines including information theory statistics engine 259 may also be used. The invention may also make use of other libraries and capabilities that are known to those skilled in the art as instrumental in the regulated trade of items of worth. Data from a plurality of sources used in trade analysis are retrieved, much of it from remote, cloud resident 201 servers through the system's distributed, extensible high bandwidth cloud interface 110 using the system's connector module 135 which is specifically designed to accept data from a number of information services both public and private through interfaces to those service's applications using its messaging service 135a routines, due to ease of programming, are augmented with interactive broker functions 235, market data source plugins 236, e-commerce messaging interpreters 237, business-practice aware email reader 238 and programming libraries to extract information from video data sources 239.

Other modules that make up the advanced cyber decision platform may also perform significant analytical transformations on trade related data. These may include the multidimensional time series data store 120 with its robust scripting features which may include a distributive friendly, fault-tolerant, real-time, continuous run prioritizing, programming platform such as, but not limited to Erlang/OTP 221 and a compatible but comprehensive and proven library of math functions of which the C++ math libraries are an example 222, data formalization and ability to capture time series data including irregularly transmitted, burst data; the GraphStack service 145 which transforms data into graphical representations for relational analysis and may use packages for graph format data storage such as Titan 245 or the like and a highly interface accessible programming interface an example of which may be Akka/Spray, although other, similar, combinations may equally serve the same purpose in this role 246 to facilitate optimal data handling; the directed computational graph module 155 and its distributed data pipeline 155a supplying related general transformer service module 160 and decomposable transformer module 150 which may efficiently carry out linear, branched, and recursive transformation pipelines during trading data analysis may be programmed with multiple trade related functions involved in predictive analytics of the received trade data. Both possibly during and following predictive analyses carried out by the system, results must be presented to clients 105 in formats best suited to convey the both important results for analysts to make highly informed decisions and, when needed, interim or final data in summary and potentially raw for direct human analysis. Simulations which may use data from a plurality of field spanning sources to predict future trade conditions these are accomplished within the action outcome simulation module 125. Data and simulation formatting may be completed or performed by the observation and state estimation service 140 using its ease of scripting and gaming engine to produce optimal presentation results.

In cases where there are both large amounts of data to be cleansed and formalized and then intricate transformations such as those that may be associated with deep machine learning, first disclosed in ¶067 of co-pending application Ser. No. 14/925,974, predictive analytics and predictive simulations, distribution of computer resources to a plurality of systems may be routinely required to accomplish these tasks due to the volume of data being handled and acted upon. The advanced cyber decision platform employs a distributed architecture that is highly extensible to meet these needs. A number of the tasks carried out by the system are extremely processor intensive and for these, the highly integrated process of hardware clustering of systems, possibly of a specific hardware architecture particularly suited to the calculations inherent in the task, is desirable, if not required for timely completion. The system includes a computational clustering module 280 to allow the configuration and management of such clusters during application of the advanced cyber decision platform. While the computational clustering module is drawn directly connected to specific co-modules of the advanced cyber decision platform these connections, while logical, are for ease of illustration and those skilled in the art will realize that the functions attributed to specific modules of an embodiment may require clustered computing under one use case and not under others. Similarly, the functions designated to a clustered configuration may be role, if not run, dictated. Further, not all use cases or data runs may use clustering.

FIG. 2A is a block diagram showing general steps 200 for performing passive network reconnaissance. It should be appreciated that the steps illustrated and described may be performed in any order, and that steps may be added or omitted as needed for any particular reconnaissance operation. In a step 201, network address ranges and domains or sub-domains associated with a plurality of targets may be identified, for example to collect information for defining the scope of further scanning operations. In another step 202, external sites may be identified to understand relationships between targets and other third-party content providers, such as trust relationships or authoritative domain name service (DNS) resolution records. In another step 203, individual people or groups may be identified using names, email addresses, phone numbers, or other identifying information that may be useful for a variety of social engineering activities. In another step 204, technologies used may be identified, such as types or versions of hardware or software used by an organization, and this may include collecting and extracting information from job descriptions (for example) to identify technologies in use by an organization (for example, a job description for an administrator familiar with specific database software indicates that the software is in use within the organization). In another step 205, content of interest may be identified, for example including web and email portals, log files, backup or archive files, and other forms of sensitive information that may be contained within HTML comments or client-side scripts, as may be useful for vulnerability discovery and penetration testing activities. In another step 206, publicly-available information may be used to identify vulnerabilities that may be exploited with further active penetration testing.

FIG. 2B is a process diagram showing a general flow of a process 210 for performing active reconnaissance using DNS leak information collection. In an initial step 211, publicly-available DNS leak disclosure information may be collected to maintain current information regarding known leaks and vulnerabilities. In a next step 212, third-level domain (TLDR) information may be collected and used to report domain risk factors, such as domains that do not resolve properly (due to malformed DNS records, for example). In a next step 213, a DNS trust map may be created using a hybrid graph/time-series data structure, using a graph stack service 145 and MDTSDB 120. This trust map may be produced as the output of an extraction process performed by a DCG 155 through a plurality of data pipelines 155a, analyzing collected data and mapping data points to produce hybrid structured output representing each data point over time. In a final step 214, the trust map may then be analyzed to identify anomalies, for example using community detection algorithms that may discover when new references are being created, and this may be used to identify vulnerabilities that may arise as a byproduct of the referential nature of a DNS hierarchy. In this manner, DCG pipeline processing and time-series data graphing may be used to identify vulnerabilities that would otherwise be obscured within a large dataset.

FIG. 2C is a process diagram showing a general flow of a process 220 for performing active reconnaissance using web application and technology reconnaissance. In an initial step 221, a plurality of manual HTTP requests may be transmitted to a host, for example to determine if a web server is announcing itself, or to obtain an application version number from an HTTP response message. In a next step 222, a robots.txt, used to identify and communicate with web crawlers and other automated “bots,” may be searched for to identify portions of an application or site that robots are requested to ignore. In a next step 223, the host application layer may be fingerprinted, for example using file extensions and response message fields to identify characteristic patterns or markers that may be used to identify host or application details. In a next step 224, publicly-exposed/admin pages may be checked, to determine if any administrative portals are exposed and therefore potentially-vulnerable, as well as to potentially determine administration policies or capabilities based on exposed information. In a final step 225, an application may be profiled according to a particular toolset in use, such as WORDPRESS™ (for example) or other specific tools or plugins.

FIG. 2D is a process diagram showing a general flow of a process 230 for producing a cybersecurity rating using reconnaissance data. In an initial step 231, external reconnaissance may be performed using DNS and IP information as described above (referring to FIG. 2B), collecting information from DNS records, leak announcements, and publicly-available records to produce a DNS trust map from collected information and the DCG-driven analysis thereof. In a next step 232, web and application recon may be performed (as described in FIG. 2C), collecting information on applications, sites, and publicly-available records. In a next step 233, collected information over time may be analyzed for software version numbers, revealing the patching frequency of target hosts and their respective applications and services. Using a hybrid time-series graph, timestamps may be associated with ongoing changes to reveal these updates over time. In a next step 234, a plurality of additional endpoints may be scanned, such as (for example, including but not limited to) internet-of-things (IoT) devices that may be scanned and fingerprinted, end-user devices such as personal smartphones, tablets, or computers, or social network endpoints such as scraping content from user social media pages or feeds. User devices may be fingerprinted and analyzed similar to organization hosts, and social media content may be retrieved such as collecting sentiment from services like TWITTER™ or LINKEDIN™, or analyzing job description listings and other publicly-available information. In a next step 235, open-source intelligence feeds may be checked, such as company IP address blacklists, search domains, or information leaks (for example, posted to public records such as PASTEBIN™). In a final step 236, collected information from all sources may be scored according to a weighted system, producing an overall cybersecurity rating score based on the information collected and the analysis of that information to reveal additional insights, relationships, and vulnerabilities.

For example, in an exemplary scoring system similar to a credit rating, information from initial Internet recon operations may be assigned a score up to 400 points, along with up to 200 additional points for web/application recon results, 100 points for patch frequency, and 50 points each for additional endpoints and open-source intel results. This yields a weighted score incorporating all available information from all scanned sources, allowing a meaningful and readily-appreciable representation of an organization's overall cybersecurity strength. Additionally, as scanning may be performed repeatedly and results collected into a time-series hybrid data structure, this cybersecurity rating may evolve over time to continuously reflect the current state of the organization, reflecting any recent changes, newly-discovered or announced vulnerabilities, software or hardware updates, newly-added or removed devices or services, and any other changes that may occur.

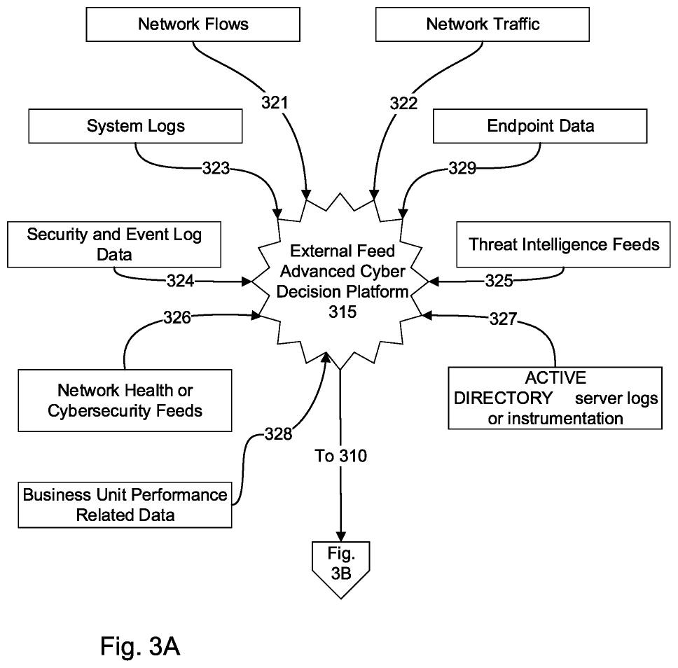

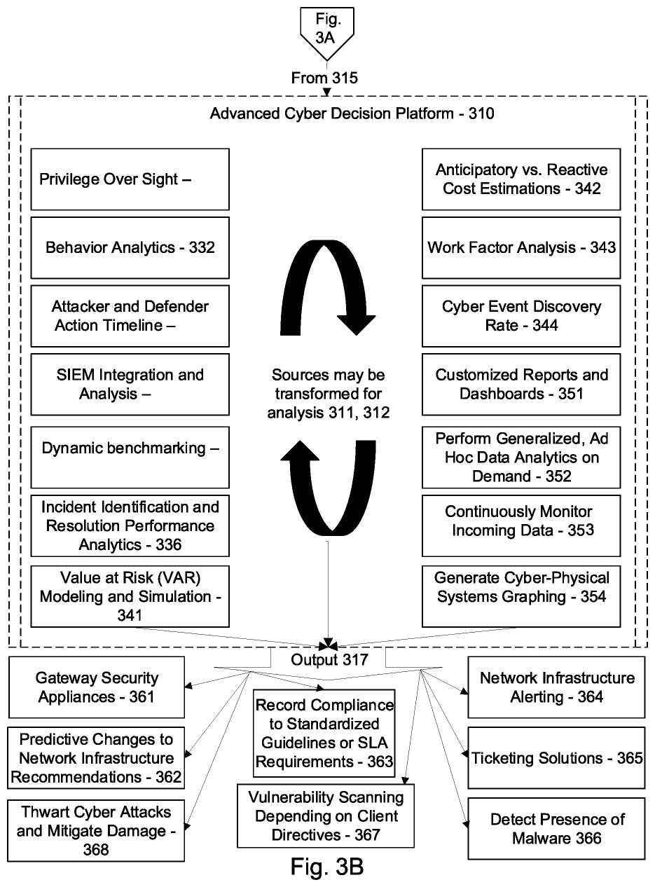

FIGS. 3A and 3B are process diagrams showing further detail regarding the operation of the advanced cyber decision platform. Input network data which may include network flow patterns 321, the origin and destination of each piece of measurable network traffic 322, system logs from servers and workstations on the network 323, endpoint data 329, any security event log data from servers or available security information and event (SIEM) systems 324, external threat intelligence feeds 324, identity or assessment context 325, external network health or cybersecurity feeds 326, Kerberos domain controller or ACTIVE DIRECTORY™ server logs or instrumentation 327, business unit performance related data 328, endpoint data 329, among many other possible data types for which the invention was designed to analyze and integrate, may pass into 315 the advanced cyber decision platform 310 for analysis as part of its cyber security function. These multiple types of data from a plurality of sources may be transformed for analysis 311, 312 using at least one of the specialized cybersecurity, risk assessment or common functions of the advanced cyber decision platform in the role of cybersecurity system, such as, but not limited to network and system user privilege oversight 331, network and system user behavior analytics 332, attacker and defender action timeline 333, SIEM integration and analysis 334, dynamic benchmarking 335, and incident identification and resolution performance analytics 336 among other possible cybersecurity functions; value at risk (VAR) modeling and simulation 341, anticipatory vs. reactive cost estimations of different types of data breaches to establish priorities 342, work factor analysis 343 and cyber event discovery rate 344 as part of the system's risk analytics capabilities; and the ability to format and deliver customized reports and dashboards 351, perform generalized, ad hoc data analytics on demand 352, continuously monitor, process and explore incoming data for subtle changes or diffuse informational threads 353 and generate cyber-physical systems graphing 354 as part of the advanced cyber decision platform's common capabilities. Output 317 can be used to configure network gateway security appliances 361, to assist in preventing network intrusion through predictive change to infrastructure recommendations 362, to alert an enterprise of ongoing cyberattack early in the attack cycle, possibly thwarting it but at least mitigating the damage 362, to record compliance to standardized guidelines or SLA requirements 363, to continuously probe existing network infrastructure and issue alerts to any changes which may make a breach more likely 364, suggest solutions to any domain controller ticketing weaknesses detected 365, detect presence of malware 366, perform one time or continuous vulnerability scanning depending on client directives 367, and thwart or mitigate damage from cyber-attacks 368. These examples are, of course, only a subset of the possible uses of the system, they are exemplary in nature and do not reflect any boundaries in the capabilities of the invention.

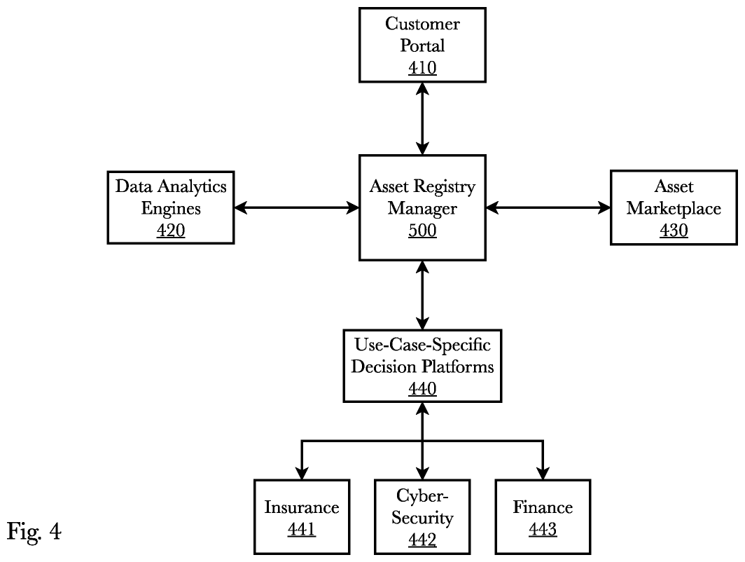

FIG. 4 is an exemplary system architecture diagram of a system for universalization and contextualization of computing assets. In this exemplary embodiment, the system comprises an asset registry manager 500, a customer portal 410, one or more data analytics engines 420, an asset marketplace 430, and a plurality of use-case-specific decision platforms 440. The core of the system is the asset registry manager 500, which stores a registry of universalized computing assets and manages their use and sharing by other components of the system. The system of this embodiment may also be viewed as a platform for use and sharing of universalized computing assets, and the term.

A customer portal 410 allows customers to access the various services available on the platform for the customer's computing needs, for example the data analytics engines 420 and decision platforms 440, as well as allowing the customer to buy, develop, and sell computing assets that it may require in the asset marketplace 430. The customer portal 410 includes tools for searching for available computing assets, retrieving the assets, and using the assets for the customer's computing needs, which may involve building of data processing workflows using multiple assets in series, in parallel, or a combination of both. The customer portal 4120 may also include a set of developer tools for creation of new assets either by uploading or creating new fundamental (level 0) assets or by building more complex higher-level computing assets by combining lower-level computing assets.

The asset marketplace 430 allows for exchange and sharing of assets. Assets available on the platform may be owned by different entities, for example the platform owner, by customers who develop the assets for their own uses, or by third parties who develop assets for the platform specifically to market them to others on the platform. The marketplace 430 provides purchase, sale, licensing, exchange, and sharing functionality for such purposes, and encourages the development of new assets by providing financial incentives to do so. The platform owner may receive or charge a fee for the sale, transfer, licensing, or use of the assets, including where the assets are owned by customers or third parties.

The use-case-specific platforms 440 are specific applications of the computing assets and data analytics engines 420 for specific purposes, for example customized sets of computing assets for analysis of insurance policies, premiums, and risks 441, cyber-security threats and mitigations 442, and financial and market predictions 443.

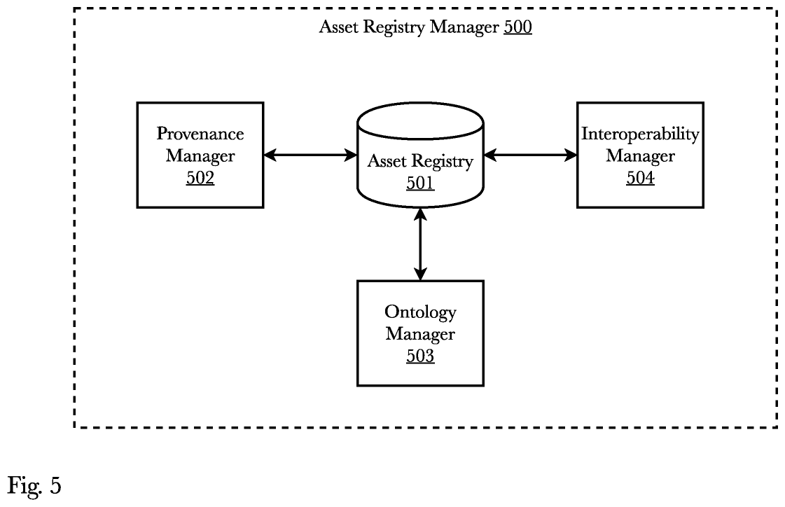

FIG. 5 is an exemplary system architecture diagram of the asset registry manager aspect of a system for universalization and contextualization of computing assets. In this embodiment, the asset registry manager 500 comprises an asset registry database 501, a provenance manager 502, an ontology manager 503, and an interoperability manager 504. The asset registry database 501 may be a centralized or distributed database.

The provenance manager 502 assigns provenance metadata to each asset in the registry and tracks that information over time. The provenance manager 502 may further keep additional provenance metadata separate from each asset which provides additional provenance information (e.g., for groups of assets, etc.). The provenance metadata may include such information as who created the asset, when the asset was created, asset source type information, where the asset is located or stored, ownership, licensing, pricing and royalty information, data validation, compliance and auditing information, trustworthiness scores, re-use, expiration and staleness, and known or suspected biases associated with the asset. In many cases, the provenance metadata may be automatically obtained, for example where a customer creates or uses an asset, that information will be stored as provenance metadata. However, in some cases the provenance information may be entered manually, for example where data are obtained from a website with a known or discernable bias, a bias indicator may be entered for the data when it is entered as an asset in the system. This provenance information can be used to determine a suitability, reliability, or trustworthiness of the asset or of outputs of workflows associated with an asset. Detailed information about data provenance tracking is contained in U.S. patent application Ser. No. 15/931,534, which has been incorporated herein by reference.

The ontology manager 503 assigns ontology metadata to each asset in the registry and creates an ontology of assets. The ontology manager 503 is responsible for cataloging relationships between computing assets from metadata assigned to each asset, including the provenance metadata in appropriate circumstances. The ontology manager 503 is also responsible for version tracking and control of ontologies, which is key to avoiding conflicts in changes to the ontologies, particularly where changes are by two different entities (or automated systems) simultaneously. For example, if an asset is in use by two different customers at the same time, and a change is made by both users, a version conflict or data loss could occur. In such cases, the ontology manager ensures version continuity by using existing best practices for version control, which procedures may differ depending on whether the asset registry database is centralized or distributed. In some cases, ontological metadata may be automatically assigned, as would be the case, for example, where a child asset is created using some part of a parent asset, in which case the parent asset and child asset would have an ontological relationship by virtue of the fact that one asset was derived from the other. In some cases, ontological metadata may be manually assigned, as would be the case, for example, where the developer of an asset designates a use case or domain for which the asset was created. In some embodiments, machine learning algorithms may be used to construct the ontologies using patterns discovered by the machine learning algorithms within metadata assigned to the assets or from data within the assets themselves. Detailed information about the development and use of schemas and ontologies is contained in U.S. patent application Ser. No. 16/864,133 and U.S. patent application Ser. No. 15/847,443, both of which have been incorporated herein by reference. The interoperability manager 504 uses asset metadata and information from the provenance manager and ontology manager to determine whether an asset is suitable for use for a particular intended purpose. The provenance metadata can be used to determine a suitability, reliability, or trustworthiness of the asset or of outputs of workflows associated with an asset. The ontological metadata can be used to determine the suitability of use of an assert in a given domain which may be different from the domain for which the asset was created, and to determine interoperability of assets created by different entities, for different purposes, or in different contexts. A combination of provenance metadata with ontological metadata can thus indicate both whether a particular asset can be used for the purpose intended by a user (ontology) and the reliability of outputs from that asset (provenance). Using the classification metadata, the interoperability manager 504 groups computing assets into groups, categories, or domains which can be browsed by a customer. When the customer browses a group, category, or domain, the interoperability manager 504, using the ontology created by the ontology manager, suggests other groups, categories, domains, or even specific assets that may also be usable for similar purposes, and further indicates a likely reliability of results that may be obtained from using those other groups, categories, domains, or assets. The suggestions and recommendations of the interoperability manager 504 may be further improved by allowing the user to enter or select a computing need or an intended purpose, and using that information to refine the suggestions. To make its classifications, recommendations, and suggestions interoperability manager 504 may use simple comparison algorithms (e.g., key words comparisons), but more sophisticated graph traversal algorithms (e.g., shortest path algorithms, etc.), clustering algorithms (e.g., relative distance between vectors or between vertices of a graph), or machine learning algorithms (e.g., a graph convolutional network) may be used to analyze the ontology created by the ontology manager (which, as mentioned previously, may include the provenance metadata).

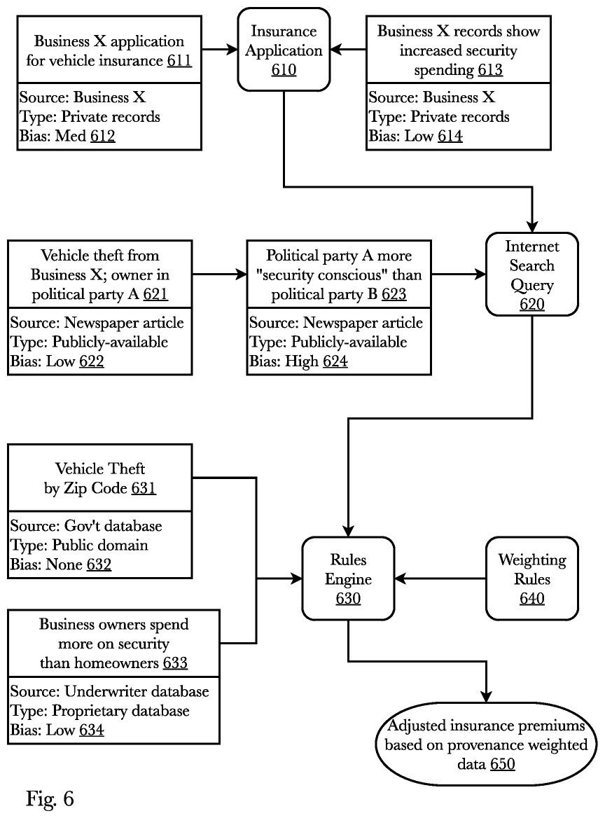

FIG. 6 is a flow diagram showing an example of the use of provenance metadata to weight the influence of different types of data on a decision. In this example, an insurance application 610 is submitted by a Business X to an insurer. The insurance application 610 contains a completed form application for vehicle insurance 611 and business records from Business X showing increased spending on security over the past year 613. The provenance manager 502 associates metadata 612 with the application 611 indicating that the source of the data is Business X, that the type of data is a private record, and that the bias of the data is medium (due to Business X having a financial interest in the matter). The provenance manager 502 associates metadata 614 with the business records 613 indicating that the source of the data is Business X, that the type of data is a private record, and that the bias of the data is low (because business records are generally trustworthy). The data from the insurance application 610 is used to conduct an internet search 620 for information about Business X, which results in a newspaper article 621 reporting a vehicle theft from Business X and notes that the owner is a member of political party A, which leads to another newspaper article 623 suggesting that members of political party A are more “security conscious” than those of political party B. The provenance manager 502 associates metadata 622 with the vehicle theft article 621, noting that the source is a newspaper article, that it is publicly-available, and that its bias is low (as it is simply reporting the vehicle theft). The provenance manager 502 associates metadata 622 with the political party article 623, noting that the source is a newspaper article, that it is publicly-available, but that its bias is high (as it is making a value judgment regarding political party affiliations). The application 610 and internet search results 620 are fed to a rules engine, which retrieves information from two databases, a database of vehicle thefts by zip code 631 and an underwriter database containing information the business owners spend more on security than homeowners 633. The provenance manager 502 associates metadata 632 with the database of vehicle thefts by zip code 631, noting that the source is a government database, that it is in the public domain, and that it has little or no bias. The provenance manager 502 associates metadata 634 with the underwriter database 633, noting that the source is an insurance underwriter, that it is a proprietary database, and that it has low bias.

Weighting rules 640 are retrieved to determine how to weight the sources, types, and biases of the data to determine an adjusted premium based on the provenance labeled data 650. In this case, the facts that the business spent more on security, that the owner is potentially more “security conscious,” and that the owner is a business owner weigh in favor of lower premiums, while the fact that a vehicle has recently been stolen and that Business X is located in a high risk zip code weight in favor of higher premiums. The tracking of provenance metadata allows these weighted determinations to be applied.

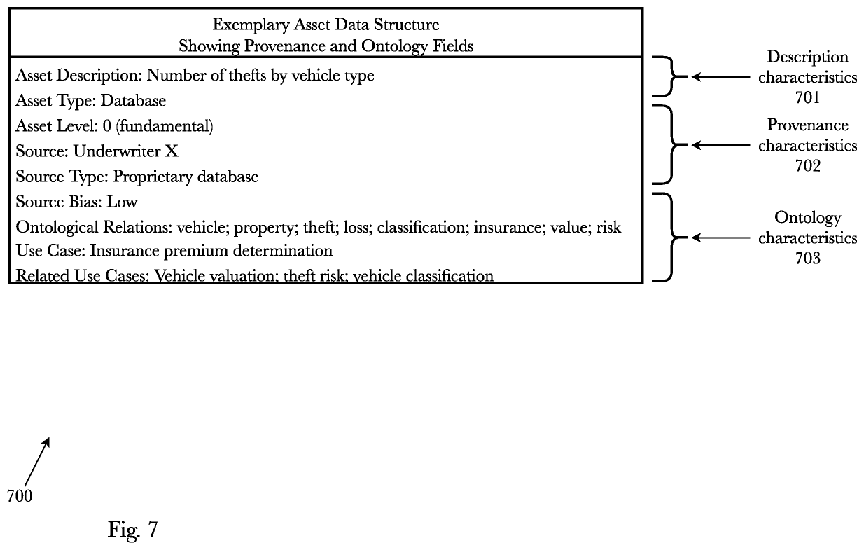

FIG. 7 is an exemplary data structure showing exemplary metadata fields that may be associated with a computing asset. In this simplified example, a data structure may contain descriptive characteristics 701 such as an asset type, an asset level, and an asset description, provenance characteristics 702 such as a data source, a data source type, and a data source bias, and ontology characteristics 703 such as ontologically related key words, a use case for which the asset was developed, and related use cases to which the asset may be applied.

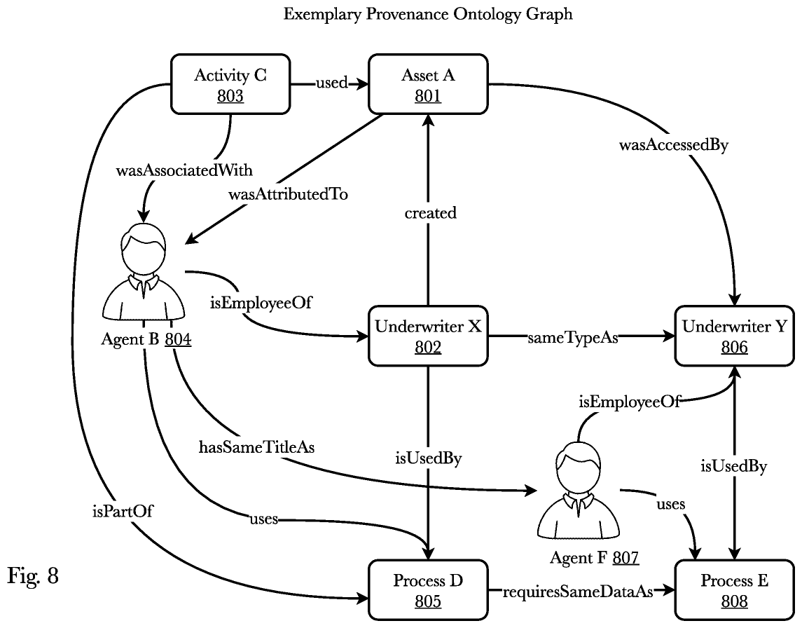

FIG. 8 is an exemplary provenance-ontology graph demonstrating how the provenance and ontological metadata may be converted to a directed graph and used to determine a possible use of a computing resource outside of the context in which the computing resource was created. In this example, Asset A 801 is a computing resource developed by Underwriter X 802 for purposes of a Process D 805 used to determine insurance premiums. Agent B 804 is an employee of Underwriter X 802, who used Asset A 801 for Activity C 803 which is part of Process D. Agent F 807 is an employee of Underwriter Y 806, and needs to determine an insurance premium, but does not have an asset like Asset A. Underwriter X 802 writes policies for vehicle insurance, while Underwriter Y 806 issues homeowner's insurance (i.e., the policies of Underwriter X 802 and Y 806 are in different domains). The ontology created by the ontology manager 503 contains information showing substantial similarities such that Asset A is a good candidate for cross-domain use in this case. For instance, Agent B 804 and Agent F 807 have the same title, Underwriter X and Underwriter Y are the same type of entity (insurance underwriters), Process D requires the same data as Process E, and Asset A was used by an activity that is part of Process D. Therefore, it is likely that Asset A could be used with some degree of reliability in Process E, and the interoperability manager 504 would recommend the use of Asset A 801 to Agent F 807 based on the ontological relationships, possibly with caveats about reliability or uncertainty in the results as indicated by the provenance metadata.

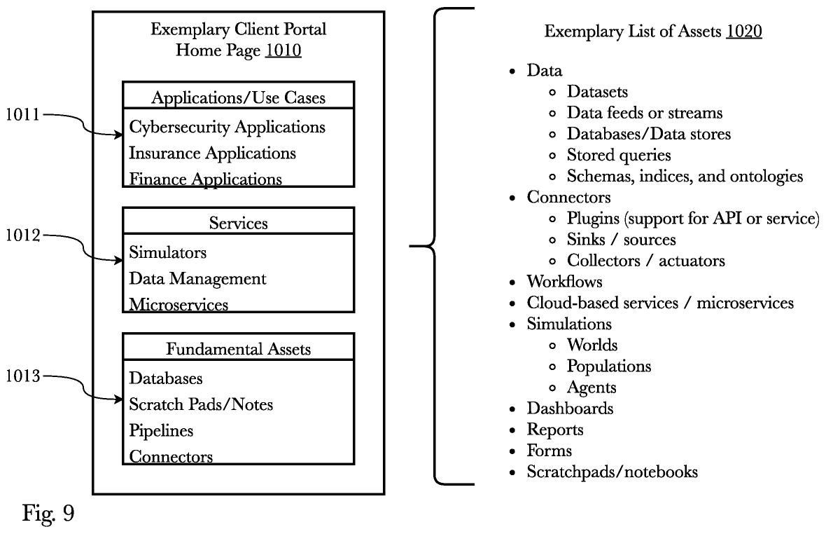

FIG. 9 is an exemplary client portal home page showing examples of universalized computing assets which a client may employ to solve computing needs. In this example, a customer's client portal home page 1010 may show a list of available computing assets by category, such as applications or use cases 1011, for example cybersecurity applications, insurance-related applications, or finance-related applications, or by available services 1012, for example simulators, data management services, or microservices, or by low-level fundamental assets 1013 such as databases containing raw data, scratchpads or notes, workflow pipelines, or data connectors. Browsing through these categories will lead to lists of computing assets available to the customer for resolution of the customer's computing needs, the lists being determined by the asset registry manager 500, as described above. The exemplary list of assets 1020 shows examples of computing assets that may be available to satisfy a customer's computing needs, including datasets, data feeds and streams, data stores or databases; stored queries, schemas, indices, ontologies; connector workflows, data transformation workflows, and data processing workflows; data sources and sinks, data collectors and actuators; plugins for application programming interfaces (APIs) or cloud-based services or microservices; models, algorithms, and simulations; rules, scratchpads, reports, notes, and forms. At lower levels of complexity, such computing assets may be very simple, such as a real-time data stream from an air temperature sensor. At higher levels of complexity, simpler assets can be combined to obtain more complex information, such as combining the data stream from the air temperature sensor with a model of a greenhouse to predict internal temperatures within the greenhouse. Using ontologies, the same sensor and model may be used in a different domain to predict the internal temperature of a car, albeit with greater uncertainty which can be reflected in to ontological relationships.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

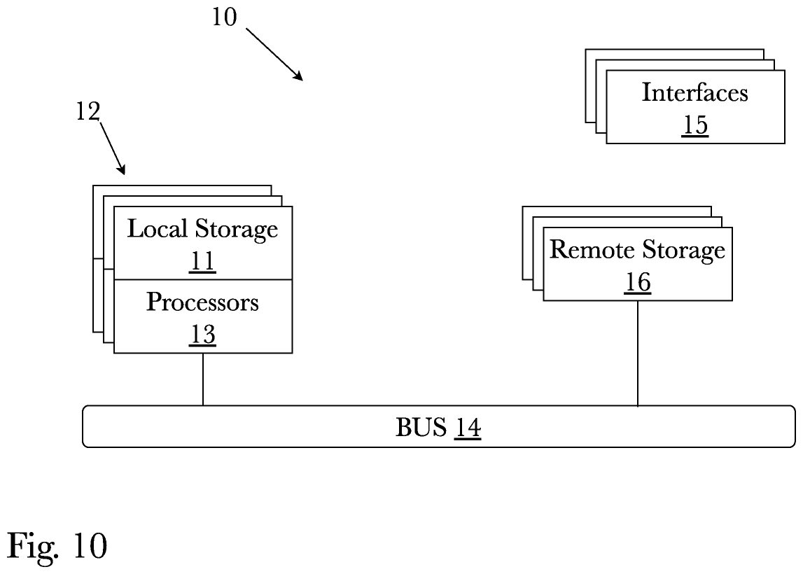

Referring now to FIG. 10, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some aspects, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™ THUNDERBOLT™, PCI, parallel, radio frequency (RF), BLUETOOTH™, near-field communications (e.g., using near-field magnetics), 802.11 (Wi-Fi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 10 illustrates one specific architecture for a computing device 10 for implementing one or more of the aspects described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, a single processor 13 handles communications as well as routing computations, while in other aspects a separate dedicated communications processor may be provided. In various aspects, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the aspects described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device aspects may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

In some aspects, systems may be implemented on a standalone computing system. Referring now to FIG. 11, there is shown a block diagram depicting a typical exemplary architecture of one or more aspects or components thereof on a standalone computing system. Computing device 20 includes processors 21 that may run software that carry out one or more functions or applications of aspects, such as for example a client application 24. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20 and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 10). Examples of storage devices 26 include flash memory, magnetic hard drive, CD-ROM, and/or the like.

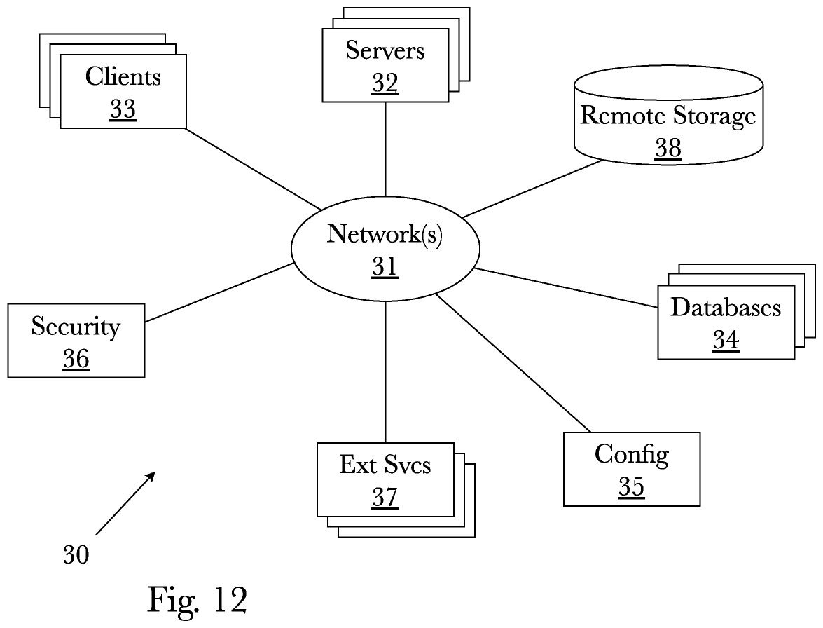

In some aspects, systems may be implemented on a distributed computing network, such as one having any number of clients and/or servers. Referring now to FIG. 12, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 10. In addition, any number of servers 32 may be provided for handling requests received from one or more clients 33. Clients 33 and servers 32 may communicate with one another via one or more electronic networks 31, which may be in various aspects any of the Internet, a wide area network, a mobile telephony network (such as CDMA or GSM cellular networks), a wireless network (such as Wi-Fi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some aspects, servers 32 may call external services 37 when needed to obtain additional information, or to refer to additional data concerning a particular call. Communications with external services 37 may take place, for example, via one or more networks 31. In various aspects, external services 37 may comprise web-enabled services or functionality related to or installed on the hardware device itself. For example, in one aspect where client applications 24 are implemented on a smartphone or other electronic device, client applications 24 may obtain information stored in a server system 32 in the cloud or on an external service 37 deployed on one or more of a particular enterprise's or user's premises. In addition to local storage on servers 32, remote storage 38 may be accessible through the network(s) 31.

In some aspects, clients 33 or servers 32 (or both) may make use of one or more specialized services or appliances that may be deployed locally or remotely across one or more networks 31. For example, one or more databases 34 in either local or remote storage 38 may be used or referred to by one or more aspects. It should be understood by one having ordinary skill in the art that databases in storage 34 may be arranged in a wide variety of architectures and using a wide variety of data access and manipulation means. For example, in various aspects one or more databases in storage 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some aspects, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, some aspects may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with aspects without limitation, unless a specific security 36 or configuration system 35 or approach is specifically required by the description of any specific aspect.

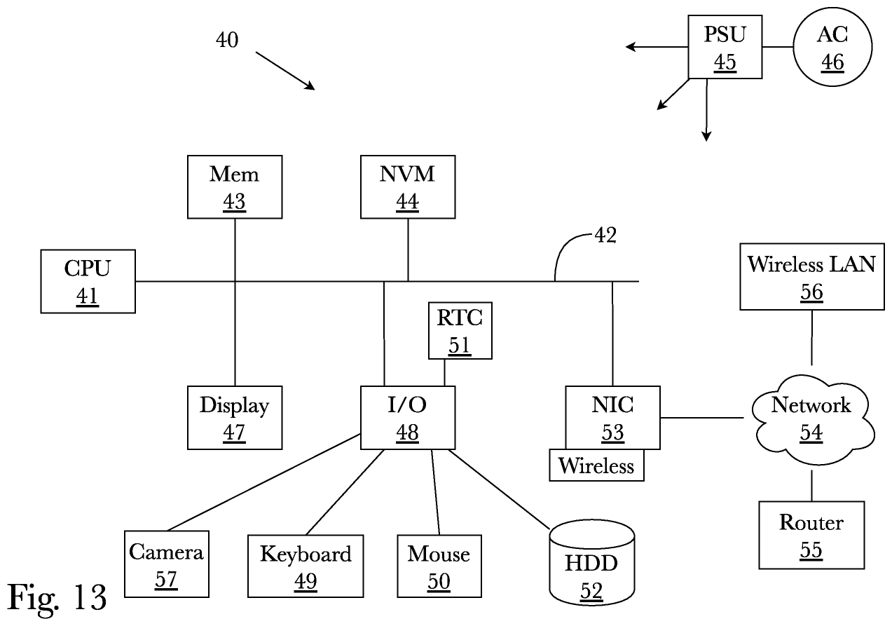

FIG. 13 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to peripherals such as a keyboard 49, pointing device 50, hard disk 52, real-time clock 51, a camera 57, and other peripheral devices. NIC 53 connects to network 54, which may be the Internet or a local network, which local network may or may not have connections to the Internet. The system may be connected to other computing devices through the network via a router 55, wireless local area network 56, or any other network connection. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various aspects, functionality for implementing systems or methods of various aspects may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various aspects described above. Accordingly, the present invention is defined by the claims and their equivalents.

What is claimed is:

1. A system for universalization of computing assets, comprising:
a computing device comprising a processor, a memory, and a non-volatile data storage device;
an asset registry stored on the non-volatile data storage device, the asset registry comprising a list of computing assets with ontology metadata for each computing asset; and
an asset registry manager comprising a first plurality of programming instructions stored in the memory and operating on the processor which cause the computing device to:
create an ontology of computing assets using the ontology metadata;
receive a computing use case selection from a user;
create a list of computing assets usable for the computing use case, the list comprising computing assets that are determined to be ontologically related to the computing use case based on the ontology; and
display the list of computing assets usable for the computing use case.

2. The system of claim 1, wherein the asset registry further comprises provenance metadata for each asset, and wherein the system further comprises a provenance manager comprising a second plurality of programming instructions stored in the memory and operating on the processor which cause the computing device to:
track the provenance of each computing asset using the provenance metadata;
for each computing asset on the list, calculate a reliability of results of the use of the computing asset for the computing use case based on the provenance metadata; and
displaying the list of computing assets usable for the computing use case with the calculated reliability of results.

3. The system of claim 2, wherein the provenance metadata for each asset further comprises bias metadata, and wherein the reliability of results includes an analysis of the bias metadata.

4. The system of claim 1, further comprising an asset marketplace comprising a third plurality of programming instructions stored in the memory and operating on the processor which cause the computing device to allow the purchase, sale, or licensing of computing assets.

5. A method for universalization of computing assets, comprising the steps of:
creating an asset registry on a non-volatile data storage device, the asset registry comprising a list of computing assets with ontology metadata for each computing asset;
creating an ontology of computing assets using the ontology metadata;
receiving a computing use case selection from a user;
creating a list of computing assets usable for the computing use case, the list comprising computing assets that are determined to be ontologically related to the computing use case based on the ontology;
for each computing asset on the list, calculating a reliability of results of the use of the computing asset for the computing use case based on the provenance metadata; and
displaying the list of computing assets usable for the computing use case.

6. The method of claim 5, wherein the asset registry further comprises provenance metadata for each asset, and further comprising the steps of:
tracking the provenance of each computing asset using the provenance metadata; and
for each computing asset on the list, calculating a reliability of results of the use of the computing asset for the computing use case based on the provenance metadata; and
displaying the list of computing assets usable for the computing use case with the calculated reliability of results.

7. The method of claim 6, wherein the provenance metadata for each asset further comprises bias metadata, and wherein the reliability of results includes an analysis of the bias metadata.

8. The method of claim 5, further comprising the step of creating an asset marketplace which allows the purchase, sale, or licensing of computing assets.
